(19) United States
(12) Patent Application Publication
(10) Pub. No.: US 2026/0164231 A1
(43) Pub. Date: Jun. 11, 2026

(54) ENERGY SAVING CONTROL IN A NETWORK

(71) Applicant: Rakuten Symphony, Inc., Setagaya-ku, Tokyo (JP)

(72) Inventors: Awn MUHAMMAD, Tokyo (JP); Pankaj Tanaji SHETE, Tokyo (JP); Lingasamy VELUCHAMY, Karnataka (IN)

(73) Assignee: Rakuten Symphony, Inc., Setagaya-ku, Tokyo (JP)

(21) Appl. No.: 18/845,469

(22) PCT Filed: Jun. 11, 2024
(86) PCT No.: PCT/US2024/033343

§ 371 Date: Sep. 10, 2024

Related U.S. Application Data
(60) Provisional application No. 63/472,498, filed on Jun. 12, 2023.

(30) Foreign Application Priority Data
Jun. 13, 2023 (IN) 202341040353
Jun. 19, 2023 (IN) 202341041647

(51) Int. Cl. H04W 8/22; H04L 41/16; H04W 52/02

(52) U.S. Cl. CPC H04W 8/22; H04L 41/16; H04W 52/0274

(57) ABSTRACT

Provided are apparatus, method, and device for automatically perform energy saving control in a network. According to embodiments, the apparatus may be configured to: transmit an energy saving capability request to a distributed unit (DU); receive, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; select a value within the capability range; and transmit the selected value to the DU.

### CROSS-REFERENCE TO RELATED APPLICATIONS

This application claims priority to Indian Provisional Patent Application No. 202341040353, filed with the Indian Patent Office on Jun. 13, 2023, Indian Provisional Patent Application No. 202341041647, filed with the Indian Patent Office on Jun. 19, 2023, and U.S. Provisional Patent Application No. 63/472,498, filed with the U.S. Patent and Trademark Office on Jun. 12, 2023, the entire contents of which are incorporated herein by reference.

### FIELD

The present disclosure relates to an energy saving control in a telecommunication network.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

FIG. 1 illustrates an O-RAN architecture in the related art. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140,150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, and O-eNB 160) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronhaul (OF) Control (C), User (U), Synchronization(S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-Ran Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

### SUMMARY

Example embodiments of the present disclosure automatically performs energy saving control. As such, example embodiments of the present disclosure allow for energy saving features to be effectively controlled and provisioned to the RU, while considering various essential aspects, such as the capability of the RU, the tradeoff between user experience and energy saving performance, and the various conditions of the network.

According to embodiments, an apparatus is provided. The apparatus may be configured to: transmit an energy saving capability request to a distributed unit (DU); receive, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; select a value within the capability range; and transmit the selected value to the DU.

According to embodiments, a method is provided. The method may include: transmitting an energy saving capability request to a distributed unit (DU); receiving, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; selecting a value within the capability range; and transmitting the selected value to the DU.

According to embodiments, a non-transitory computer-readable recording medium is provided. The non-transitory computer-readable recording medium may have recorded thereon instructions executable by an apparatus to cause the apparatus to perform a method including: transmitting an energy saving capability request to a distributed unit (DU); receiving, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; selecting a value within the capability range; and transmitting the selected value to the DU.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an O-RAN architecture in the related art;

FIG. 2A to FIG. 2B illustrate a flow sequence of an example use case for performing energy saving control with carrier and cell switch off/on, according to one or more embodiments;

FIG. 3A to FIG. 3B illustrate a flow sequence of an example use case for performing energy saving control with RF channel switch off/on, according to one or more embodiments;

FIG. 3C to FIG. 3D illustrate a flow sequence of an example use case for performing energy saving control with RF channel switch off/on, according to one or more embodiments;

FIG. 4A to FIG. 4B illustrate a flow sequence of an example use case for performing energy saving control with ASM, according to one or more embodiments;

FIG. 4C to FIG. 4D illustrate a flow sequence of an example use case for performing energy saving control with ASM, according to one or more embodiments;

FIG. 5 illustrates a flow diagram of an example method for performing energy saving control, according to one or more embodiments;

FIG. 6 illustrates a flow sequence of an example use case for performing energy saving control, according to one or more embodiments;

FIG. 7 illustrates a flow diagram of an example method for performing energy saving control, according to one or more embodiments;

FIG. 8 illustrates a flow sequence of an example use case for performing energy saving control, according to one or more embodiments; and

FIG. 9 illustrates a diagram of example components of a device for implementing one or more example embodiments.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

The foregoing disclosure provides illustration and description but is not intended to be exhaustive or to limit the implementations to the precise form disclosed. Modifications and variations are possible in light of the above disclosure or may be acquired from practice of the implementations.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “ASM”, “TRX”, “rApp”, “xApp”, and the like, as well as the associated features and operations, are to be interpreted as consistent with those specified in one or more technical specifications.

Further, although some embodiments of the present disclosure may be described herein with reference specific components of 5G system, it can be understood that the scope of the present disclosure should not be limited thereto. Specifically, example embodiments of the present disclosure may also apply to any suitable network elements in any suitable telecommunication system, such as a 4G LTE system, a 6G system, and the like, without departing from the scope of the present disclosure.

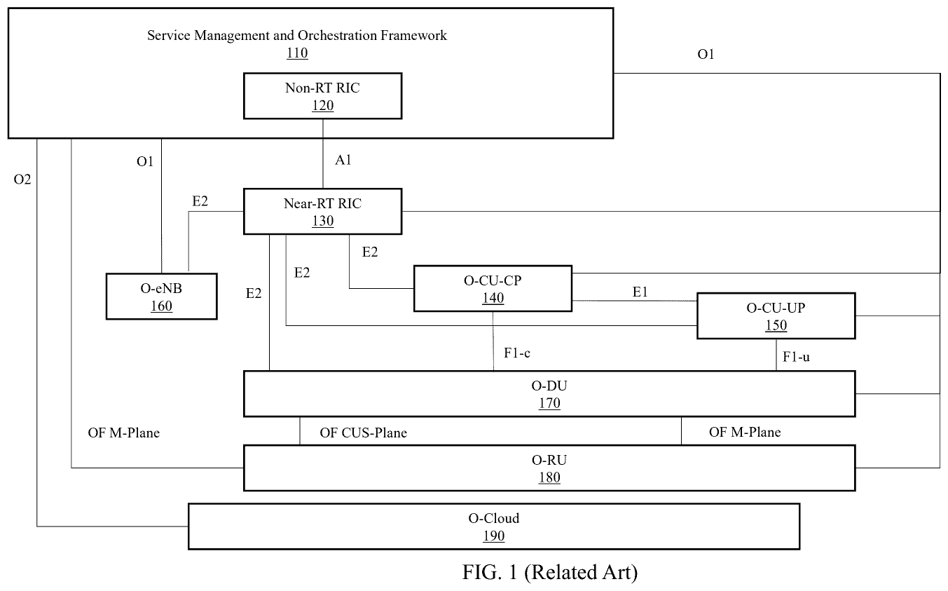

As described above in relation to FIG. 1, the RAN may be disaggregated into multiple nodes or entities. Specifically, in the O-RAN architecture, the RAN functions may be disaggregated into multiple logical nodes or entities, such as a central unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. A single DU may host or serve multiple network cells formed by multiple RUs. The RU may be a physical node that converts radio signals from antennas to digital signals that can be transmitted over the Front Haul to a DU. In this regard, a network cell may correspond to one or more radio units responsible for providing wireless coverage and signal transmission within the network cell. To this end, since the disaggregated entities have open protocols and interfaces between them, they can be developed by different vendors.

On the other hand, network energy-saving is an important aspect of O-RAN in order to optimize energy efficiency, reduce operating costs, and minimize carbon footprint, while maintaining high network performance and ensuring high quality of service (QoS). In the related art, the concept of policy-based Advanced Sleep Mode (ASM) and Antenna mask control (TRX Control) for energy-saving has been introduced. Nevertheless, the specific manner in which the above mechanisms are controlled and provisioned to the RU are not specified or defined in the related art. In this regard, since entities from different vendors may be involved in the O-RAN architecture, it is crucial to define and specify the control and provisioning for energy-saving in a standardized manner, such that entities from different vendors can understand the policies and operate accordingly for energy-saving.

Accordingly, apparatuses, systems, methods, devices, and the like, provided in the example embodiments of the present disclosure automatically perform energy saving control.

According to embodiments, the apparatus may obtain an energy saving capability of a radio unit (RU) from a distributed unit (DU), where the energy saving capability may specify at least one of: a plurality of sleep modes of an Advanced Sleep Mode (ASM) and a plurality of array modes of an antenna mask (TRX) control that can be performed by the RU, and where the energy saving capability also specify a capability range associated with the at least one of: the plurality of sleep modes and the plurality of array modes. The apparatus may then select a value within the capability range and transmit the selected value to the DU, such that the DU may execute at least one of: a sleep mode of the plurality of sleep modes and an array mode of the plurality of array modes associated with the selected value.

Ultimately, example embodiments of the present disclosure automatically perform energy saving control, which allows for energy saving features to be effectively controlled and provisioned to the RU, while considering various essential aspects, such as the capability of the RU, the tradeoff between user experience and energy saving performance, and the various conditions of the network.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the apparatus of the present disclosure, according to one or more embodiments, are provided in the following.

### Example Energy Saving Methods

In ORAN, various energy saving concepts have been introduced, examples of which include carrier and cell switch off/on, Radio Frequency (RF) switch off/on (also referred to as RF channel reconfiguration), and Advanced Sleep Mode (ASM).

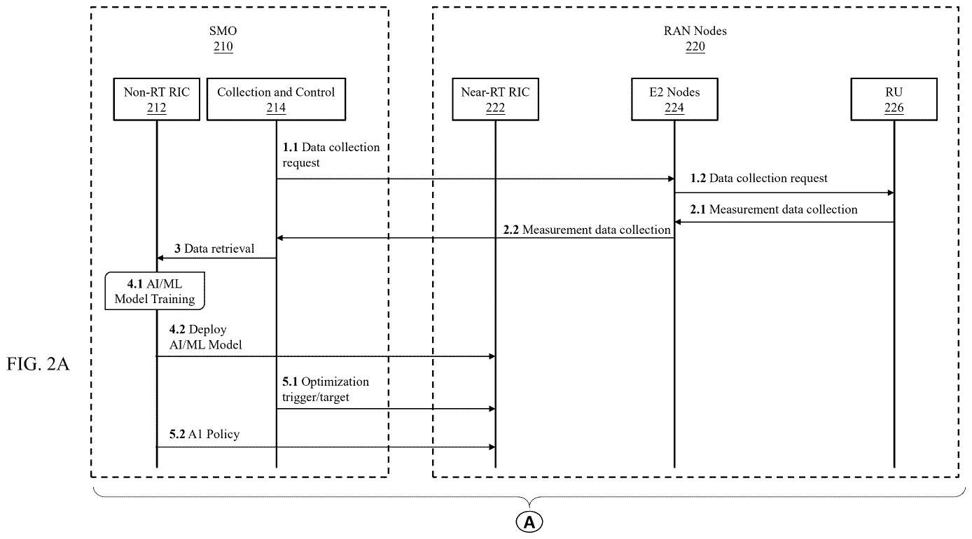

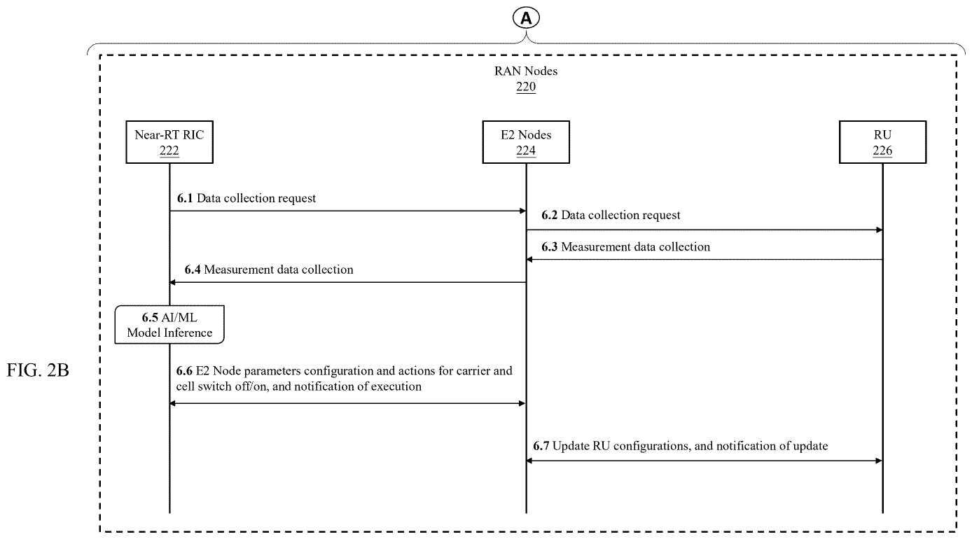

FIG. 2A to FIG. 2B illustrate a flow sequence of an example use case for performing energy saving control with carrier and cell switch off/on, according to one or more embodiments. The carrier and cell switch off/on may refer to a process where one or more carriers and/or one or more cells are switched off in order to save energy.

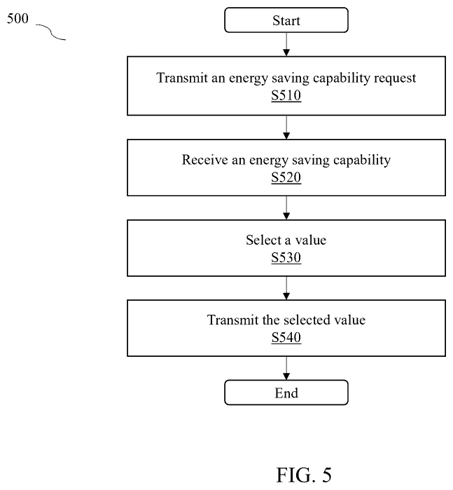

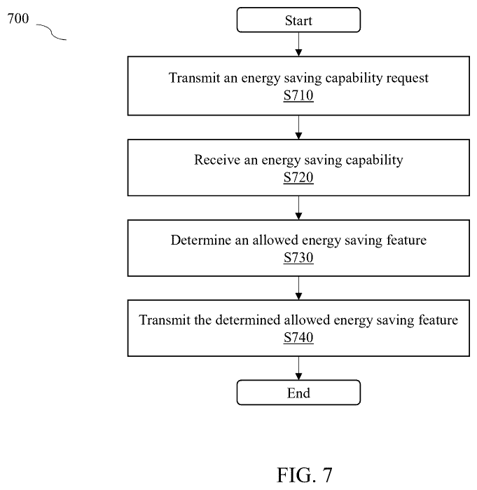

As shown in FIG. 2A to FIG. 2B, the flow sequence may involve a Service Management and Orchestration (SMO) framework 210 and RAN nodes 220, where the SMO 210 may include a Non-RT RIC 212 and a collection and control network function 214, and the RAN nodes 220 may include a Near RT-RIC 222, E2 nodes 224 (CU, DU, and the like), and RU 226. The SMO 210, Non-RT RIC 212, Near RT-RIC 222, E2 nodes 224, and RU 226 may be similar to the SMO 110, Non-RT RIC 120, Near RT-RIC 130, O-CU 140/150, O-eNB 160, O-DU 170, and O-RU 180 described above in relation to FIG. 1. Further, one or more operations in FIG. 2A to FIG. 2B may involve or may be part of one or more operations described below with reference to FIG. 5 and FIG. 7.

At step 1.1, the collection and control network function 214 may transmit a data collection request for energy saving to the E2 nodes 224 via an O1 interface, where the E2 nodes 224 may then forward the data collection request to the RU 226 at step 1.2 via a fronthaul plane (e.g., M plane, C plane, and the like of the Open Fronthaul).

At step 2.1, the RU 226 may transmit measurement data for energy saving to the E2 nodes 224 via the fronthaul plane, where the E2 nodes 224 may then forward the measurement data to the collection and control network function 214 at step 2.2 via the O1 interface.

At step 3, the Non-RT RIC 212 may retrieve data from the collection and control network function 214 (e.g., measurement data received from the E2 nodes 224 and the like). The above steps 1 to 3 may be collectively referred to as data collection process.

At step 4.1, the Non-RT RIC 212 may perform Artificial Intelligence (AI)/Machine Learning (ML) model training to train an AI/ML model based on the data retrieved from the collection and control network function 214. The Non-RT RIC 212 may then deploy the trained AI/ML model to the Near-RT RIC 222 at step 4.2 via the O1 interface or an O2 interface, where the Near-RT RIC 222 may use the trained AI/ML model to perform inference (i.e., at step 6.5 below). Steps 4.1 to 4.2 may be collectively referred to as AI/ML workflow process involving data analysis and training. Further, step 4.1, as well as steps 1.1 to 3 may be repeated to further train the AI/ML model.

At step 5.1 to 5.2, the collection and control network function 214 may transmit an optimization trigger/target to the Near-RT RIC 222 via the O1 interface, and the Non-RT RIC 212 may transmit an A1 policy to the Near-RT RIC 222.

The A1 policy may refer to a policy that is generated and provided from the Non-RT RIC 212 to the Near-RT RIC 222 via an A1 interface, and may be a declarative policy that contains information applicable to one or more network nodes (e.g., one or more UEs, one or more network cells, and the like), as well as information associated with energy-saving (e.g., carrier and cell switch off/on and the like). The A1 policy may consist of a scope identifier and one or more policy statements. The scope identifier may represent what the policy statements are to be applied on (e.g., cells, UEs, DUs, RUs etc.) The policy statements may define the goals or objectives of the policy and may include information associated with one or more policy objectives and one or more policy resources. The Non-RT RIC 212 may provide the one or more A1 policies to the Near-RT RIC 222, thereby providing guidance to the Near-RT RIC 222 towards one or more objectives or goals defined in the RAN intent. The RAN intent may refer to the high-level operational or business goal(s) to be achieved by the RAN, which may be defined by one or more desired service level agreements (SLAs) that the RAN is to fulfill for all users or for a subset of users in a given area over at least a predefined period of time.

Steps 5.1 to 5.2 may be collectively referred to as optimization trigger and policy process.

At step 6.1, the Near-RT RIC 222 may transmit a data collection request for energy saving to the E2 nodes 224 via an E2 interface, where the E2 nodes 224 may then forward the data collection request to the RU 226 at step 6.2 via the fronthaul plane. The RU 226 may then transmit measurement data for energy saving to the E2 nodes 224 at step 6.3 via the fronthaul plane, where the E2 nodes 224 may then forward the measurement data to the Near-RT RIC 222 at step 6.4 via the E2 interface.

At step 6.5, the Near-RT RIC 222 may perform AI/ML model inference to determine appropriate E2 node parameters configuration and actions for carrier and cell switch off/on based on the data obtained from the RU 226 during steps 6.3 to 6.4 using the trained AI/ML model deployed during step 4.2.

At step 6.6, the Near-RT RIC 222 may transmit the determined E2 node parameters configuration and actions for carrier and cell switch off/on to the E2 nodes 224 via the E2 interface, where the E2 nodes 224 may then transmit a notification of execution of the E2 node parameters configuration and actions for carrier and cell switch off/on back to the Near-RT RIC 222 via the E2 interface.

At step 6.7, the E2 nodes 224 may update the configurations of the RU 226 in accordance with the received E2 node parameters configuration and actions for carrier and cell switch off/on via the fronthaul plane, where the RU 226 may then transmit a notification of update back to the E2 nodes 224 via the fronthaul plane. Steps 6.1 to 6.7 may be collectively referred to as action data collection and decision making process.

In view of the above, energy saving can be achieved by switching off one or more carriers or entire cells based on AI/ML model using measured data (e.g., traffic data such as load, user location, service type, mobility, energy efficiency measurements, and the like) without impacting user experience.

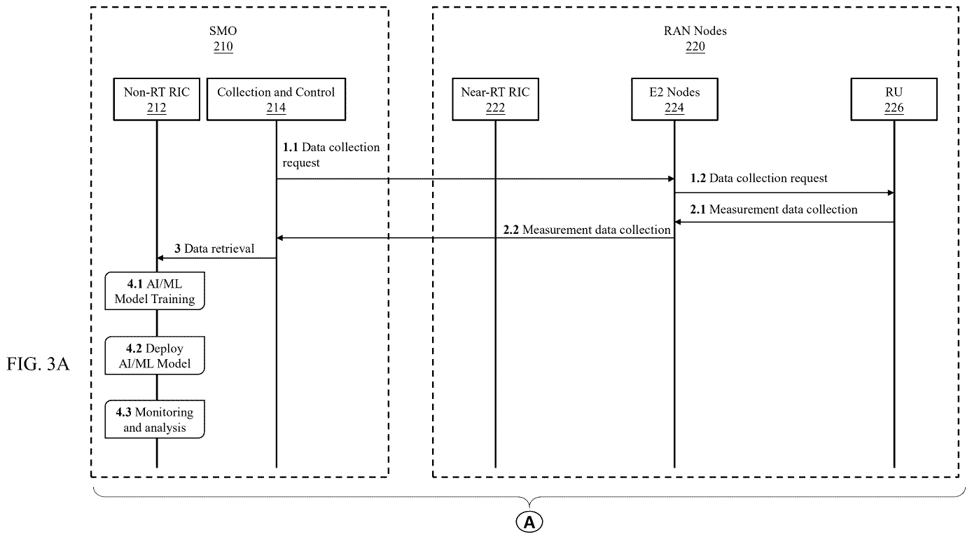

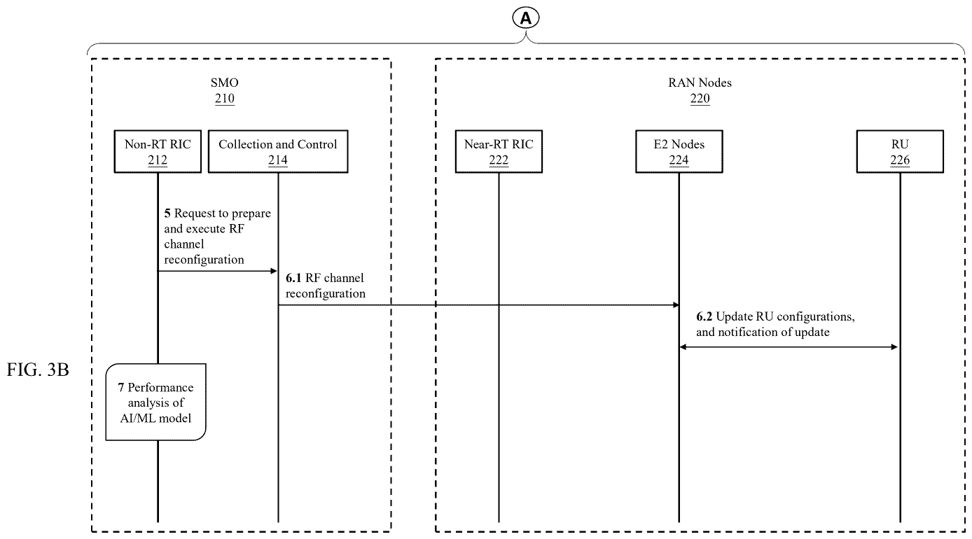

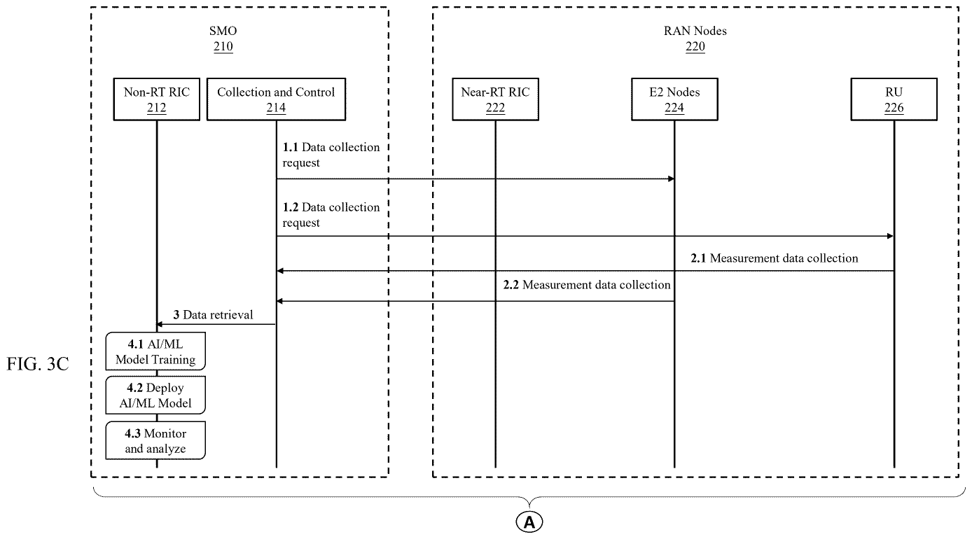

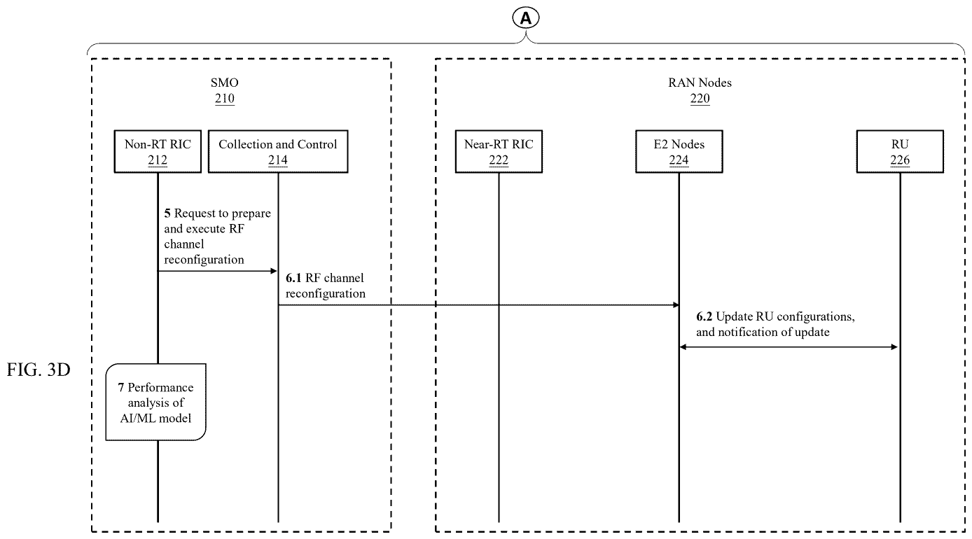

FIG. 3A to FIG. 3B illustrates a flow sequence of an example use case for performing energy saving control with RF channel switch off/on, according to one or more embodiments. The RF channel switch off/on may refer to a process where RF channels of the RU are switched off in order to save energy. The RF channel switch off/on may involve antenna mask control (TRX control), where antenna array elements (i.e., transmit antenna arrays (tx-arrays), receiving antenna arrays (rx-arrays), and the like) of the RU are switched off in order to save energy. For example, using AI/ML model, rApp hosted at the Non-RT RIC 212 or xApp hosted at the Near-RT RIC 222 may trigger switching off/on certain RF channels, based on traffic data such as load, user location, service type, mobility, energy efficiency measurements, and the like; where 32 out of 64 antenna elements of a massive MIMO antenna may be turned off (TRX control). According to example embodiments, the antenna mask control (TRX control) may also involve disabling one or more components of the RU, such as O-RAN fronthaul processing unit, digital processing unit, RF processing unit, and the like. The RF channel switch off/on may also involve data layer control, where the number of data layers may be reduced in order to save energy.

As shown in FIG. 3A to FIG. 3B, the flow sequence may involve a Service Management and Orchestration (SMO) framework 210 and RAN nodes 220, where the SMO 210 may include a Non-RT RIC 212 and a collection and control network function 214, and the RAN nodes 220 may include a Near RT-RIC 222, E2 nodes 224 (CU, DU, and the like), and RU 226. The SMO 210, Non-RT RIC 212, Near RT-RIC 222, E2 nodes 224, and RU 226 may be similar to the SMO 110, Non-RT RIC 120, Near RT-RIC 130, O-CU 140/150, O-eNB 160, O-DU 170, and O-RU 180 described above in relation to FIG. 1. Further, one or more operations in FIG. 3A to FIG. 3B (as well as FIG. 3C to FIG. 3D) may involve or may be part of one or more operations described below with reference to FIG. 5 and FIG. 7.

At step 1.1, the collection and control network function 214 may transmit a data collection request for energy saving to the E2 nodes 224 via an O1 interface, where the E2 nodes 224 may then forward the data collection request to the RU 226 at step 1.2 via a fronthaul plane (e.g., M plane, C plane, and the like of the Open Fronthaul).

At step 2.1, the RU 226 may transmit measurement data for energy saving to the E2 nodes 224 via the fronthaul plane, where the E2 nodes 224 may then forward the measurement data to the collection and control network function 214 at step 2.2 via the O1 interface.

At step 3, the Non-RT RIC 212 may retrieve data from the collection and control network function 214 (e.g., measurement data received from the E2 nodes 224 and the like). The above steps 1 to 3 may be collectively referred to as data collection process.

At step 4.1, the Non-RT RIC 212 may perform Artificial Intelligence (AI)/Machine Learning (ML) model training to train an AI/ML model based on the data retrieved from the collection and control network function 214. The Non-RT RIC 212 may then deploy and activate the trained AI/ML model at the Non-RT RIC 212 at step 4.2, where the Non-RT RIC 212 may use the trained AI/ML model to perform inference. Once the trained AI/ML model is deployed, the Non-RT RIC 212 may perform monitoring and analysis of energy efficiency and energy consumption of the E2 node 224 and the RU 226 at step 4.3. Step 4.1, as well as steps 1.1 to 3 may be repeated to further train the AI/ML model.

At step 5, the Non-RT RIC 212 may determine RF channel reconfiguration based on the energy efficiency and energy consumption of the E2 node 224 and the RU 226 that were monitored and analyzed at step 4.3, and transmit a request to prepare and execute the RF channel reconfiguration for energy saving to the collection and control network function 214.

At step 6.1, the collection and control network function 214 may transmit the RF channel reconfiguration for energy saving to the E2 nodes 224 via the O1 interface. Then, at step 6.2, the E2 nodes 224 may update the configurations of the RU 226 in accordance with the RF channel reconfiguration via the fronthaul plane, where the RU 226 may then transmit a notification of update back to the E2 nodes 224 via the fronthaul plane. Steps 5 to 6.2 may be collectively referred to as actor decision making process.

At step 7, the Non-RT RIC 212 may perform a performance analysis of the AI/ML model. The performance analysis of the AI/ML model may be performed, for example, for fallback, re-training, and the like. Steps 4.1 to 7 may be collectively referred to as AI/ML workflow process involving data analysis training and inference.

FIG. 3C to FIG. 3D illustrates a flow sequence of an example use case for performing energy saving control with RF channel switch off/on, according to one or more embodiments. The flow sequence shown in FIG. 3C to FIG. 3D may be similar to the flow sequence shown in FIG. 3A to FIG. 3B, with changes to steps 1.1, 1.2, 2.1, and 2.2.

In particular, at step 1.1 the collection and control network function 214 may transmit a data collection request for energy saving to the E2 nodes 224 via an O1 interface, as well as to the RU 226 at step 1.2 via a fronthaul plane (e.g., M plane, C plane, and the like of the Open Fronthaul).

At step 2.1, the RU 226 may transmit measurement data for energy saving directly to the collection and control network function 214 via the fronthaul plane, and the E2 nodes 224 may also transmit the measurement data to the collection and control network function 214 at step 2.2 via the O1 interface.

In view of the above, energy saving can be achieved by switching off one or more RF channels based on AI/ML model using measured data without impacting user experience.

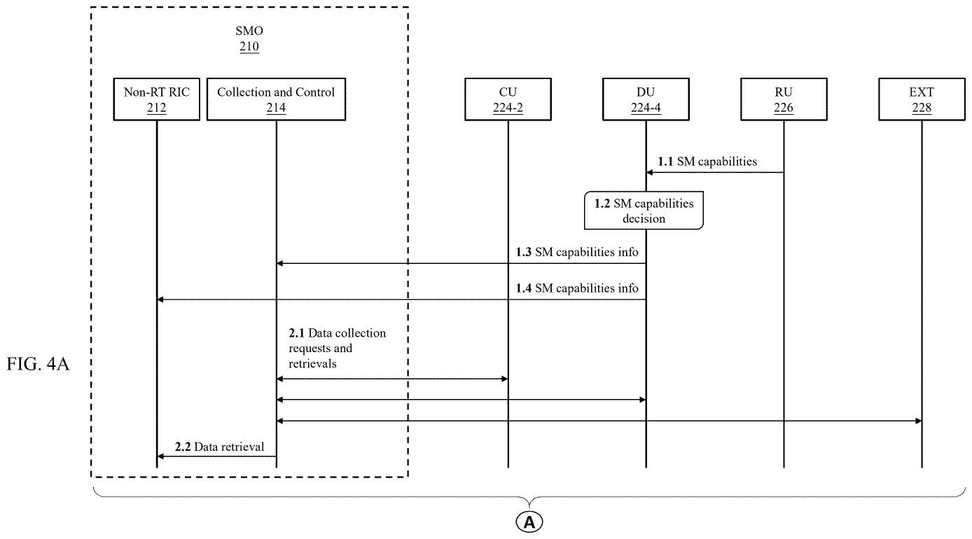

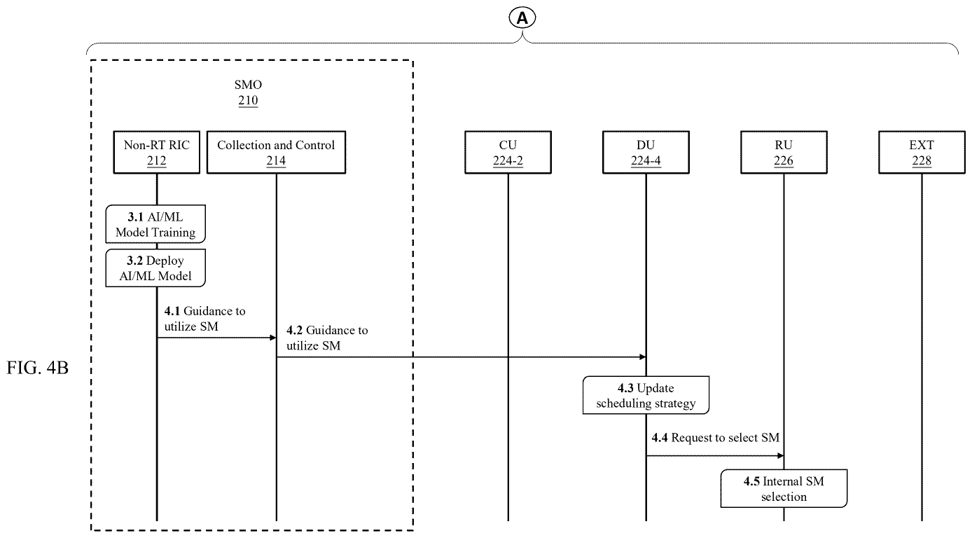

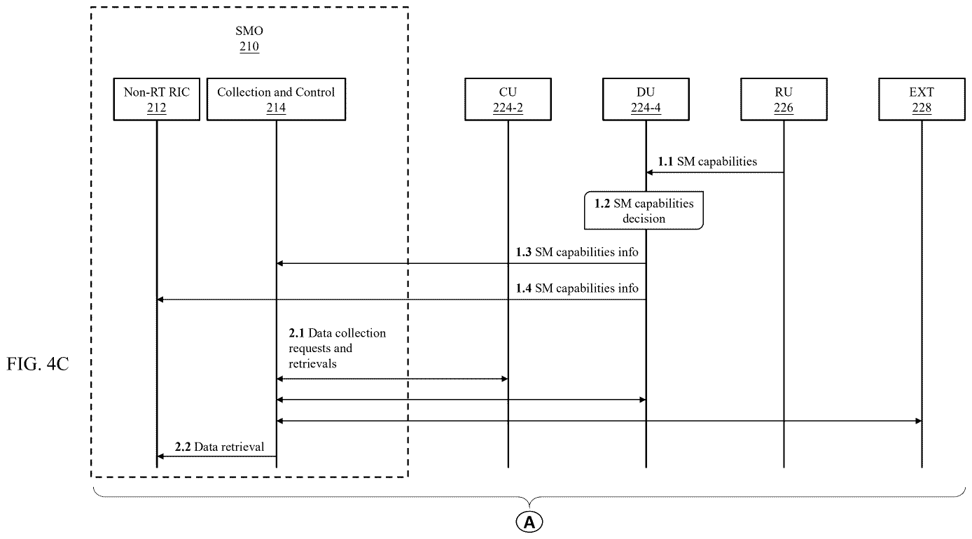

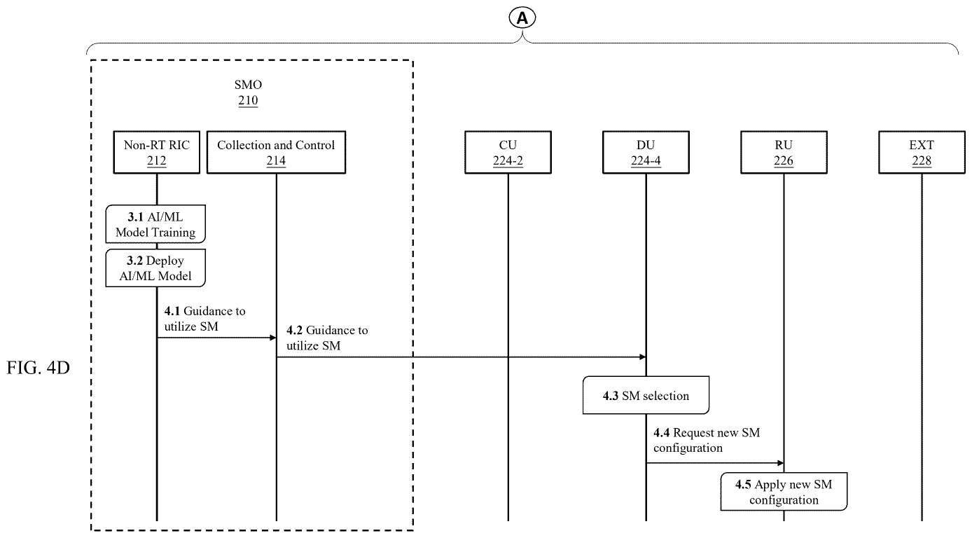

FIG. 4A to FIG. 4B illustrates a flow sequence of an example use case for performing energy saving control with ASM, according to one or more embodiments. The ASM may refer to a process where components of the RU are switched off for a certain time duration in order to save energy. In particular, the ASM may include a plurality of sleep modes (SMs), where each of the plurality of sleep modes may be associated with at least one component of the RU and a certain time duration. For Example, the ASM may include AM1, SM2, and SM3, where SM1 may be associated with Time Division Duplex (TDD) switches of an RF processing unit of the RU and a first time duration, SM2 may be associated with the TDD switches, transceiver and CAL switch of the RF processing unit of the RU, a digital processing unit of the RU, and a second time duration, and SM3 may be associated with the TDD switches, transceiver and CAL switch of the RF processing unit of the RU, the digital processing unit of the RU, a Low-Physical Layer processing unit of an O-RAN fronthaul processing unit of the RU, an enhanced Common Public Radio Interface (eCPRI) C-Plane, S-Plane, and M-Plane processing unit of the O-RAN fronthaul processing unit of the RU, and a third time duration. Accordingly, when an SM is applied, the associated components of the RU may be switched off for the associated time duration.

The ASM may also involve configuring cell parameters, such as Synchronization Signal Block (SSB) periodicity. In particular, the SSB may be utilized in a cell search procedure where a UE acquires time and frequency synchronization of a cell and detects a Cell ID of that cell in order to connect to that cell. The time and frequency synchronization and Cell ID may be acquired based on a Primary Synchronization Signal (PSS), Secondary Synchronization Signal (SSS), and Physical Broadcast Channel (PBCH) in the SSB transmitted from a cell. It may be understood that Synchronization Signal Block and Synchronization Signal and Physical Broadcast Channel (PBCH) Block may refer to a same element. Accordingly, cell parameters, such as the SSB periodicity, may be configured as needed for the operation of ASM using multi-dimensional data such as traffic load, user service type, energy efficiency measurements, and the like.

As shown in FIG. 4A to FIG. 4B, the flow sequence may involve a Service Management and Orchestration (SMO) framework 210 including a Non-RT RIC 212 and a collection and control network function 214, CU 224-2, DU 224-4, RU 226, and EXT 228. The SMO 210, Non-RT RIC 212, CU 224-2, DU 224-4, and RU 226 may be similar to the SMO 110, Non-RT RIC 120, O-CU 140/150, O-eNB 160, O-DU 170, and O-RU 180 described above in relation to FIG. 1. Further, EXT may refer to an external system, device, and the like that provides training data for training AI/ML model. Further, one or more operations in FIG. 4A to FIG. 4B (as well as FIG. 4C to FIG. 4D) may involve or may be part of one or more operations described below with reference to FIG. 5 and FIG. 7.

At step 1.1, the RU 226 may transmit sleep mode (SM) capabilities to the DU 224-4 via a fronthaul plane (e.g., M plane, C plane, and the like of the Open Fronthaul), where the DU 224-4 may determine capabilities of the RU 226 to perform sleep mode based on such SM capabilities during step 1.2. The DU 224-4 may then transmit the determined capabilities of the RU 226 to the collection and control network function 214 via an O1 interface during step 1.3, and to the Non-RT RIC 212 via an E2 interface during step 1.4. The above steps 1.1 to 1.4 may be collectively referred to as initialization process.

At step 2.1, the collection and control network function 214 may transmit a data collection request for energy saving to the CU 224-2 via the O1 interface, to the DU 224-4 via the O1 interface, and to the EXT 228, where the CU 224-2 may transmit measurement data for energy saving to the collection and control network function 214 via the O1 interface, the DU 224-4 may transmit measurement data for energy saving to the collection and control network function 214 via the O1 interface, and the EXT 228 may transmit measurement data for energy saving to the collection and control network function 214. Subsequently, at step 2.2, the Non-RT RIC 212 may retrieve data from the collection and control network function 214 (e.g., measurement data received from the CU 224-2, DU 224-4, EXT 228, and the like). The above steps 2.1 to 2.2 may be collectively referred to as data collection process (e.g., data collection for training and inference).

At step 3.1, the Non-RT RIC 212 may perform Artificial Intelligence (AI)/Machine Learning (ML) model training to train an AI/ML model based on the data retrieved from the collection and control network function 214. The Non-RT RIC 212 may then deploy the trained AI/ML model at the Non-RT RIC 212 at step 3.2, where the Non-RT RIC 212 may use the trained AI/ML model to perform inference. Step 3.1, as well as steps 2.1 to 2.2 may be repeated to further train the AI/ML model. Step 3.2 may also be repeated to perform multiple inferences. Steps 3.1 to 3.2 may be collectively referred to as AI/ML workflow process involving data analysis training and inference.

At step 4.1, the Non-RT RIC 212 may determine guidance for the DU 224-4 and the RU 226 to utilize the SM, and transmit such guidance to the collection and control network function 214, where the collection and control network function 214 may then forward such guidance to the DU 224-4 via the O1 interface during step 4.2.

Once the DU 224-4 receives the above guidance, the DU 224-4 may update the scheduling strategy in accordance with the guidance during step 4.3, and transmit a request to select an SM to the RU 226 during step 4.4, where the RU 226 may then perform internal SM selection in accordance with the guidance during step 4.5.

Steps 4.1 to 4.5 may be repeated as necessary to provide suitable SM guidance to the DU 224-4 and the RU 226. Steps 4.3 to 4.4 may be collectively referred to as configuration update process, and steps 4.1 to 4.5 may be collectively referred to as SM guidance process.

FIG. 4C to FIG. 4D illustrates a flow sequence of an example use case for performing energy saving control with ASM, according to one or more embodiments. The flow sequence shown in FIG. 4C to FIG. 4D may be similar to the flow sequence shown in FIG. 4A to FIG. 4B, with changes to steps 4.3 and 4.5.

In particular, at step 4.3, once the DU 224-4 receives the guidance from the collection and control network function 214, the DU 224-4 may select a suitable SM based on the guidance (e.g., select SM1). The DU 224-4 may then transmit a request to apply new SM configuration to the RU 226 via the fronthaul plane during step 4.4, where the RU 226 may then apply the new SM configuration during step 4.5.

In view of the above, energy saving can be achieved by switching off one or more components of the RU for a certain period of time based on AI/ML model using measured data without impacting user experience.

It can be understood that the configuration illustrated in FIG. 2 to FIG. 4 are provided for descriptive purpose, and is not intended to limit the scope of the present disclosure in any way. Further, one or more steps described in relation to FIG. 2 to FIG. 4 may be modified and/or combined with each other.

### Example Operations for Performing Energy Saving Control in the Present Disclosure

In the following, several example operations are performable by the apparatus of one or more example embodiments of the present disclosure are described with reference to FIG. 5 to FIG. 8.

FIG. 5 illustrates a flow diagram of an example method 500 for performing energy saving control, according to one or more embodiments. One or more operations in method 500 may be performed by the apparatus of one or more example embodiments of the present disclosure. The apparatus may be configured to perform energy saving control.

According to example embodiments, the apparatus may include an SMO, a Non-RT RIC, or a Near-RT RIC, where the Non-RT RIC may be communicatively coupled to the Near-RT RIC via an A1 interface.

As illustrated in FIG. 5, at operation S510, the apparatus may be configured to transmit an energy saving capability request. The energy saving capability request may be transmitted to a distributed unit (DU), and may specify a request for the DU to transmit an energy saving capability of a radio unit (RU) associated with the DU.

Once the DU receives the energy saving capability request, the DU may transmit the energy saving capability of the RU to the apparatus. According to example embodiments, the DU may request the energy saving capability of the RU from the RU in response to receiving the energy saving capability request. According to example embodiments, the RU may report its energy saving capability to the DU prior to the DU receiving the energy saving capability request (e.g., during start up, initialization, operation, and the like). According to example embodiments, the RU may report its energy saving capability to the DU via a fronthaul plane, such as the M Plane of the Open Fronthaul. The method then proceeds to operation S520.

At operation S520, the apparatus may be configured to receive the energy saving capability of the RU associated with the DU. The energy saving capability may be received from the DU, and may specify energy saving features that are supported (i.e., can be performed) by the RU. According to example embodiments, the energy saving capability may include at least one of: a plurality of sleep modes of an Advanced Sleep Mode (ASM) and a plurality of array modes of an antenna mask (TRX) control that can be performed by the RU.

According to example embodiments, each of the plurality of sleep modes of the ASM may be associated with a component of the RU and a sleep duration, where the sleep duration may specify a duration when the associated component of the RU is disabled. For example, the ASM may include 2 sleep modes (SM): SM1 and SM2, where SM1 may be associated with an RF processing unit of the RU and a first duration, and SM2 may be associated with the RF processing unit and a digital processing unit of the RU and a second duration (e.g., longer than the first duration). Accordingly, when SM1 is executed, the RF processing unit of the RU may be disabled for the first duration, and when SM2 is executed, the RF processing unit and the digital processing unit of the RU may be disabled for the second duration. The component of the RU may include any physical and functional components in the RU, such as O-RAN fronthaul processing unit, digital processing unit, RF processing unit, antenna elements (e.g., transmitting antenna array (tx-array), receiving antenna array (rx-array), and the like), component carriers, and the like.

According to example embodiments, the ASM may also specify a transition time, which specifies a minimum time required to transition the component of the RU from being disabled to being enabled, and vice versa. According to example embodiments, each of the plurality of sleep modes of the ASM may be associated with a wake-up duration, where the wake-up duration may specify a duration when the associated component of the RU is enabled.

According to example embodiments, each of the plurality of array modes of the TRX control may be associated with an antenna element of the RU that is to be disabled. The antenna element may include an antenna element from an antenna array comprised in the RU, such as a transmitting antenna array (tx-array), a receiving antenna array (rx-array), and the like. For example, the TRX control may include 2 array modes: a first array mode and a second array mode, where the first array mode may be associated with a first group of antenna elements from the tx-arrays, and the second array mode may be associated with a second group of antenna elements from the tx-array and the rx-arrays. Accordingly, when the first array mode is executed, the first group of antenna elements may be disabled (i.e., the first array mode may specify a configuration where all antenna elements of the RU except the first group of antenna elements are enabled), and when the second array mode is executed, the second group of antenna elements may be disabled (i.e., the second array mode may specify a configuration where all antenna elements of the RU except the second group of antenna elements are enabled). According to example embodiments, the TRX control may also specify a transition time, which specifies a minimum time required to transition from a baseline configuration (e.g., configuration where all antenna elements of the RU are enabled) to a configuration associated with the plurality of array modes. For example, the transition time from a baseline configuration of a 64TRx antenna array to a 32TRx antenna array configuration may be 0.5 milliseconds.

In view of the above, for example, the energy saving capability of the RU may include SM1 and SM2, first array mode and second array mode, or all SM1, SM2, first array mode, and second array mode, which can be performed by the RU.

Further, the energy saving capability may also include a capability range associated with the at least one of: the plurality of sleep modes and the plurality of array modes.

According to example embodiments, the capability range may include a range of natural numbers (values). According to example embodiments, each of the value within the capability range may be associated with at least one of: a sleep mode of the plurality of sleep modes and an array mode of the plurality of array modes. For example, the capability range may include a range of value from 1 to 3 (i.e., 1, 2, and 3), where value 1 may be associated with SM1, value 2 may be associated with SM2, and value 3 may be associated with SM2 and first array mode.

According to example embodiments, the capability range may specify an aggressiveness (aggressiveness level) in which the RU can perform energy saving features, and may specify such aggressiveness in a range from a first value representing a maximum user experience and a minimum energy saving performance of the RU to a second value representing a minimum user experience and a maximum energy saving performance of the RU.

For example, value 1 may correspond to the value representing a maximum user experience and a minimum energy saving performance of the RU, since value 1 is associated with SM1 where only the RF processing unit of the RU may be disabled for the first duration. On the other hand, value 3 may correspond to the value representing a minimum user experience and a maximum energy saving performance of the RU, since value 3 is associated with SM2 and first array mode where the RF processing unit and the digital processing unit of the RU may be disabled for the second duration and the first group of antenna elements may be disabled.

According to example embodiments, the energy saving capability may further specify an interface supported by the RU to perform an energy saving feature. For example, the energy saving capability may specify M-Plane, C-Plane (e.g., Section Type 4 (ST4) C-Plane message), and the like of the Open Fronthaul supported by the RU, where energy saving features (i.e., ASM, TRX control, and the like) may be implemented to the RU via such interface.

According to example embodiments, the energy saving capability may further specify any additional information related to energy saving features supported by the RU and/or any additional information related to the RU itself. For example, the energy saving capability may specify valid antenna mask values, achievable energy saving ratio per antenna array configuration, and the like associated with TRX control. In another example, the energy saving capability may specify achievable energy saving ratio per sleep mode, permitted sleep duration extension, emergency wake-up, and the like associated with the ASM. In further another example, the energy saving capability may specify internal architecture (e.g., functional blocks, antenna array architecture, and the like) of the RU. The method then proceeds to operation S530.

At operation S530, the apparatus may be configured to select a value within the capability range. According to example embodiments, the selected value within the capability range may be associated with at least one of: a sleep mode of the plurality of sleep modes and an array mode of the plurality of array modes to be executed by the DU.

According to example embodiments, the apparatus may be configured to select the value within the capability range by determining an aggressiveness level in which the RU should perform energy saving features, and selecting a value within the capability range corresponding to such aggressiveness level. For example, the apparatus may determine that the RU should perform energy saving features with maximum aggressiveness level, and may select value 3 from within the capability range.

The apparatus may determine the aggressiveness level in which the RU should perform energy saving features using any means. According to example embodiments, the apparatus may select the value within the capability range (determine the aggressiveness level) using an AI/ML model. According to example embodiments, the apparatus may determine the aggressiveness level in which the RU should perform energy saving features based on a performance of the network (e.g., traffic load, energy saving efficiency measurements, Key Performance Indicators (KPIs), and the like) using an AI/ML model trained based on historical records. Accordingly, according to example embodiments, the apparatus may be configured to also monitor the performance of the network, as well as train the AI/ML model based on historical records of the performance. It may be understood that energy saving related KPI metric may be identified according to different Work Groups (WG) of the O-RAN Alliance. For example, WG4 may identify energy saving related KPI metrics for RU, WG5 may identify energy saving related KPI metrics for CU and DU, and WG6 may identify energy saving related KPI metrics for the O-Cloud.

According to example embodiments, the apparatus may determine the aggressiveness level in which the RU should perform energy saving features based on a requirement. According to example embodiments, the requirement may include a performance target that the RU is required to achieve. For example, the requirement may include a minimum Quality of Service (QoS) target (e.g., based on user Packet Data Convergence Protocol (PDCP) latency, throughput, and the like). Accordingly, the apparatus may determine the aggressiveness level that is as high as possible while ensuring that the minimum Quality of Service (QoS) target is achieved. According to example embodiments, the requirement may include an energy saving target that the RU is required to achieve. For example, the requirement may include a maximum energy consumption target. Accordingly, the apparatus may determine the aggressiveness level that is as low as possible while ensuring that the maximum energy consumption target is maintained. According to example embodiments, the apparatus may determine the aggressiveness level that can satisfy both performance target and energy saving target.

According to example embodiments, high aggressive level may indicate that the DU should schedule compress more user data into Transmission Time Intervals (TTIs).

According to example embodiments, the capability range may be in a form of a knob, where the apparatus may be configured to dynamically change a value of the knob based on a tradeoff between the user experience and the energy saving performance of the RU. The method then proceeds to operation S540

At operation S540, the apparatus may be configured to transmit the selected value in order to trigger an energy saving feature/use case. The selected value may be transmitted to the DU, such that the DU may execute the at least one of: the sleep mode of the plurality of sleep modes and the array mode of the plurality of array modes associated with the selected value. For example, the apparatus may select value 3 from within the capability range, and transmit value 3 to the DU. Accordingly, the DU may execute the SM2 and first array mode which are associated with the value 3.

According to example embodiments, the selected value may be transmitted to the DU via an O1 interface, such that the energy saving features may be triggered through the O1 interface to the RU via the DU. According to example embodiments, the selected value may be transmitted to the DU along with a request to trigger an energy saving feature. According to example embodiments, the DU may analyze the request and the selected value in order to determine which energy saving feature to execute (i.e., in order to determine the at least one of: the sleep mode of the plurality of sleep modes and the array mode of the plurality of array modes associated with the selected value).

According to example embodiments, the at least one of: the sleep mode of the plurality of sleep modes and the array mode of the plurality of array modes associated with the selected value (i.e., the determined at least one of: the sleep mode of the plurality of sleep modes and the array mode of the plurality of array modes) may be executed by the DU via a C-Plane message in the fronthaul. According to example embodiments, the at least one of: the sleep mode of the plurality of sleep modes and the array mode of the plurality of array modes associated with the selected value may be executed by the DU via a Section Type 4 (ST4) C-Plane message.

According to example embodiments, the ST4 C-Plane message may be used to specify (send) slot level configuration from the DU to the RU, which may apply to one or more endpoints in the RU (i.e., all endpoints belonging to a carrier, all endpoints associated with a tx-array/rx-array, all the endpoints in the RU, and the like). According to example embodiments, the slot level configuration may be specified for multiple extended antenna-carrier identifiers (eAxC IDs) with one or more ST4 configuration commands.

According to example embodiments, the ST4 configuration commands may include a TRX control command, which may be defined to allow energy saving by disabling (putting to sleep) one or more antenna elements in an antenna array of the RU (e.g., tx array, rx-array, and the like). According to example embodiments, the TRX control command may include an antenna mask parameter specifying a specific antenna element that is to be disabled or enabled. For example, the antenna mask parameter may specify a value “0” for antenna elements to be disabled, and a value “1” for antenna elements to be enabled.

According to example embodiments, the ST4 configuration commands may include an ASM command, which may be defined to allow energy saving by disabling (putting to sleep) one or more components of the RU for a duration of time in order to reduce some or an entire processing of the RU. According to example embodiments, when the ASM command pertains to an antenna array, the ASM command may pertain to all antenna elements in the array (e.g., all antenna elements in the tx-array, rx array, and the like). According to example embodiments, the ASM command may include a sleep mode parameter specifying a specific sleep mode. According to example embodiments, the sleep mode parameter may specify a maximum number of sleep modes (e.g., 4 sleep modes) which are based on a wake-up duration.

According to example embodiments, the ST4 C-Plane message may specify a time duration for activating the energy saving features. According to example embodiments, the ST4 C-Plane message may include a “numSlots” parameter and “numSlotsExt” parameter to specify a time duration (slot) for activating the energy saving features. According to example embodiments, the “numSlots” parameter and “numSlotsExt” parameter may be set to zero in order to activate the energy saving features for longer or for undefined duration.

According to example embodiments, the ST4 C-Plane message may also specify a command scope, which may include at least one of CARRIER-COMMAND, ARRAY-COMMAND, and O-RU-COMMAND.

According to example embodiments, the DU may use the ST4 C-Plane message to apply a sleep mode/array mode to the RU (i.e., apply configurations associated with a sleep mode/array mode to the RU), where the RU may then apply the sleep mode/array mode using the ST4 C-Plane message. According to example embodiments, the DU may use the ST4 C-Plane message together with a Section Extension (e.g., SE 10 messages, SE 11 messages, SE 16 messages, SE 19 messages, and the like).

According to example embodiments, the apparatus may also be configured to receive a performance counter. The performance counter may be measured by and received from the DU.

According to example embodiments, the performance counter may indicate counters related to the performance of the DU/RU when performing an energy saving method (feature), and may be defined based on different energy saving methods for Work Group 4 (WG4) and Work Group 5 (WG5) in the following Table 1, and for Work Group 3 (WG3) and Work Group 2 (WG2) in the following Table 2.

TABLE 1
Counters required for energy saving features for WG4 and WG5

| | WG4 | WG5 (O-DU Calculates/Count and Report |
|---|---|---|
| Energy Saving Method | (Fronthaul) | via O1 or E2) |
| Carrier Cell Switch On/Off | OR.ORU.EPE-STATS | Number of times Carrier Cell |
| | | Switch On/Off |
| | | Sum of Seconds when Carrier/Cell |
| | | was in energy savings mode. |
| RF Channel Switch On/Off | OR.ORU.EPE-STATS | Number of Times Each TRX |
| TRX Control | | Configuration is executed (during a |
| | | ROP) |
| | | & |
| | | Total Time for each configuration |
| | | (during a ROP) |
| | | Times each energy savings KNOB |
| | | TRX Control is utilized |
| | | Count of Times and total time |
| | | (seconds) Each ASM with TRX |
| | | control was executed on O-RU) |
| RF Channel Switch On/Off | OR.ORU.EPE-STATS | Number of Times O-DU restricted |
| Layer Control | | O-RU to lower Layer Mode |
| | | (Specific number of Layers) (during |
| | | a ROP) |
| | | & |
| | | Total Time for each configuration |
| | | (during a ROP) |
| Advanced Sleep Mode | OR.ORU.EPE-STATS | Number of Times O-DU sent O-RU |
| | | to a particular advance sleep mode. |
| | | & |
| | | Total Time for each configuration |
| | | (during a ROP) |
| | | Times each energy savings KNOB |
| | | for Advance sleep modes is utilized |

TABLE 2
Counters required for energy saving features for WG2 and WG3

| | WG3 | WG2 |
|---|---|---|
| Energy Saving Method | (E2SM KPM - E2 AP) | (A1 TD or R1 TD) |
| Carrier Cell Switch On/Off | KPM define Cell/Carrier | Energy Consumption of O-RU |
| | configuration for Energy | Number of times Carrier/Cell |
| | Savings Mode | Shutdown due to ES |
| | Energy Consumption | Number of Times O-RU |
| | | configuration changed to O-RU |
| | | Hardware Energy savings Mode |
| RF Channel Switch On/Off | E2SM KPM Definition | O1 Definition for Energy Savings |
| TRX Control | for Energy Savings | Number of times O-RU is Power |
| | Number of times O-RU is | Saving mode through TRX |
| | Power Saving mode | Control |
| | through TRX Control | Total time in each ES TRX |
| | Total time in each ES | configuration |
| | configuration | Total energy consumption of |
| | Times each energy | O-RU or cell |
| | savings KNOB TRX | |
| | Control is utilized | |
| | Total energy consumption | |
| | of O-RU or cell | |
| RF Channel Switch On/Off | E2SM KPM Definition | A1 TD/R1 TD Definition for |
| Layer Control | for Energy Savings | Energy Savings |
| | Number of times O-RU is | Number of times O-RU is in |
| | in particular Power | particular Power Saving mode |
| | Saving mode through | through Layer Control |
| | Layer Control | Total time in each ES |
| | Total time in each ES | configuration |
| | configuration | Total energy consumption of |
| | | O-RU or cell |
| Advanced Sleep Mode | E2SM KPM Definition | A1 TD/R1 TD Definition for |
| | for Energy Savings | Energy Savings |
| | Number of times O-RU is | Number of times O-RU is in |
| | in particular Sleep Mode | particular Power Saving mode |
| | Total time in each ES | through Sleep modes |
| | configuration | Total time in each Sleep Mode |
| | Total energy consumption | configuration |
| | of O-RU or cell | Total energy consumption of |
| | | O-RU or cell |

According to example embodiments, the performance counter for TRX control for WG5 may be defined in the following Table 3.

TABLE 3
Counters definition

| Measurement- | | report- | | |
|---|---|---|---|---|
| group | measurement-object | info | object-unit | Note |
| nes- | TRX_CONTROL_{—} | count | RU, | Type yang: counter64 is used for the |
| measurement- | CONFIG_X_TIME | | TRANSPORT, | count. When object-unit is EAXC_ID, |
| objects | | | OR EAXC_ID | TRANSPORT is reported as additional |
| | | | | parameter for EAXC_ID. |
| | TRX_CONTROL_{—} | count | RU, | Type yang: counter64 is used for the |
| | CONFIG_{—} | | TRANSPORT, | count. When object-unit is EAXC_ID, |
| | TRANSITION_{—} | | OR EAXC_ID | TRANSPORT is reported as additional |
| | TIME | | | parameter for EAXC_ID. |
| | TRX_CONTROL_{—} | max | Hardware | Type decimal64 including 4 fraction- |
| | CONFIG_X_{—} | min | component | digits for max, min, average. Power |
| | POWER | average | type e.g., | measured using method specified in |
| | | | O-RAN-RADIO, | clause 5.1.1.19 of 3GPP TS 28.552 [57] |
| | | | O-RU-POWER- | Unit of power: watts (W) Temperature |
| | | | AMPLIFIER, | measured using method specified in |
| | | | O-RU-FPGA, | clause 5.1.1.19 of 3GPP TS 28.552 [57] |
| | | | power-supply, | Unit of temperature: Celsius Voltage |
| | | | fan, cpu | measured using method as specified in |
| | | | | clause 5.1.1.19 of 3GPP TS 28.552 [57] |
| | | | | Unit of voltage: Volts Current measured |
| | | | | using method specified in clause |
| | | | | 5.1.1.19 of 3GPP TS 28.552 [57] Unit of |
| | | | | current: Ampere. |

According to example embodiments, the performance counter for ASM for WG4 may be defined in the following Table 4.

TABLE 4
Counters definition

| Measurement- | measurement- | report- | | |
|---|---|---|---|---|
| group | object | info | object-unit | Note |
| nes- | ASM_MODE_{—} | count | RU, | Type yang: counter64 is used for the |
| measurement- | X_TIME | | TRANSPORT, | count. When object-unit is EAXC_ID, |
| objects | | | OR EAXC_ID | TRANSPORT is reported as additional |
| | | | | parameter for EAXC_ID. |
| | ASM_MODE_{—} | count | RU, | Type yang: counter64 is used for the |
| | WAKE_UP_{—} | | TRANSPORT, | count. When object-unit is EAXC_ID, |
| | TIME | | OR EAXC_ID | TRANSPORT is reported as additional |
| | | | | parameter for EAXC_ID. |
| | ASM_MODE_{—} | max | Hardware | Type decimal64 including 4 fraction- |
| | X_POWER | min | component | digits for max, min, average. Power |
| | | average | type e.g., | measured using method specified in |
| | | | O-RAN-RADIO, | clause 5.1.1.19 of 3GPP TS 28.552 [57] |
| | | | O-RU-POWER- | Unit of power: watts (W) Temperature |
| | | | AMPLIFIER, | measured using method specified in |
| | | | O-RU-FPGA, | clause 5.1.1.19 of 3GPP TS 28.552 [57] |
| | | | power-supply, | Unit of temperature: Celsius Voltage |
| | | | fan, cpu | measured using method as specified in |
| | | | | clause 5.1.1.19 of 3GPP TS 28.552 [57] |
| | | | | Unit of voltage: Volts Current measured |
| | | | | using method specified in clause |
| | | | | 5.1.1.19 of 3GPP TS 28.552 [57] Unit of |
| | | | | current: Ampere. |

According to example embodiments, the performance counter may be associated with Energy, Power, and Environmental (EPE) stats measurement, and may be defined in the following Table 5.

TABLE 5
Performance Counter Table

| | |
|---|---|
| Measurement Name | OR.ORU.EPE-STATS |
| Description | The epe-stats include the performance measurement |
| | for energy, power and environmental parameters. |
| | This counter would be useful to quantify the energy |
| | saving achieved |
| Collection Method | CC (Cumulative Counter) |
| Condition | TRx control/ASM |
| Measurement Result | Energy saving related performance counters |
| Measurement Type | OR.ORU.EPE-STATS |
| Measurement | aggregation (O-RU) |
| Object Class | |
| Switching | Packet Switched |
| Technology | |
| Generation | 5GS |
| Purpose | Network Operator's Energy Saving Community |

According to example embodiments, the performance counter may be associated with power measurement, and may be defined in the following Table 6.

TABLE 6
Performance Counter Table

| | |
|---|---|
| Measurement Name | OR.ORU.POWER |
| Description | The epe-stats include the performance measurement |
| | for energy, power and environmental parameters. |
| | This counter would be useful to quantify the energy |
| | saving achieved |
| Collection Method | CC (Cumulative Counter) |
| Condition | TRx control/ASM |
| Measurement Result | Power |
| Measurement Type | OR.ORU.POWER |
| Measurement | aggregation (O-RU) |
| Object Class | |
| Switching | Packet Switched |
| Technology | |
| Generation | 5GS |
| Purpose | Network Operator's Energy Saving Community |

According to example embodiments, the performance counter may be associated with current measurement, and may be defined in the following Table 7.

TABLE 7
Performance Counter Table

| | |
|---|---|
| Measurement Name | OR.ORU.Current |
| Description | The epe-stats include the performance measurement |
| | for energy, power and environmental parameters. |
| | This counter would be useful to quantify the energy |
| | saving achieved |
| Collection Method | CC (Cumulative Counter) |
| Condition | TRx control/ASM |
| Measurement Result | CURRENT |
| Measurement Type | OR.ORU.POWER |
| Measurement | aggregation (O-RU) |
| Object Class | |
| Switching | Packet Switched |
| Technology | |
| Generation | 5GS |
| Purpose | Network Operator's Energy Saving Community |

Upon performing operation S540, the method 500 may be ended or be terminated. Alternatively, method 500 may return to operation S510, such that the apparatus may be configured to repeatedly perform, for at least a predetermined amount of time, the transmitting the energy saving capability request (at operation S510), the receiving the energy saving capability (at operation S520), the selecting the value (at operation S530), and the transmitting the selected value (at operation S540).

For example, the apparatus may have performed operations S510 to S540. Then the apparatus may monitor the performance of the network and detect a change in the performance of the network. Accordingly, the apparatus may return to operation S530 to select a new value based on the current performance of the network, and transmit the new value to the DU in operation S540.

In view of the above, example embodiments of the present disclosure allow for energy saving features to be effectively controlled and provisioned to the RU, while considering the capability of the RU and the tradeoff between user experience and energy saving performance.

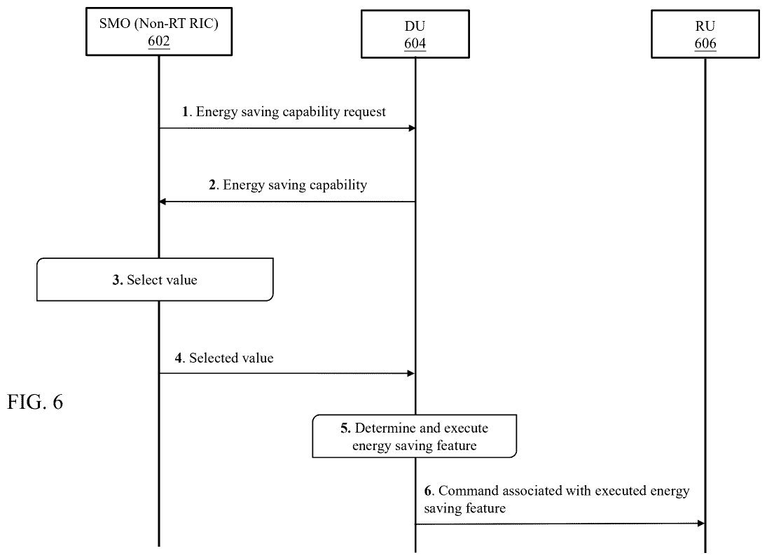

FIG. 6 illustrates a flow sequence of an example use case for performing energy saving control, according to one or more embodiments. As shown in FIG. 6, the flow sequence may involve an SMO/Non-RT RIC 602, DU 604, and RU 606. The SMO/Non-RT RIC 602, DU 604, and RU 606 may be similar to the SMO 110, Non-RT RIC 120, O-DU 170, and O-RU 180 described above in relation to FIG. 1. Further, one or more operations in FIG. 6 may involve or may be part of one or more operations described above with reference to FIG. 5. For instance, steps 1 to 4 in FIG. 6 may be similar to operations S510 to S540 in FIG. 5, respectively.

At step 1, the SMO/Non-RT RIC 602 may transmit a data collection request to the DU 604 in the similar manner as described above in relation to operation S510. The data collection request may be transmitted via, for example, an O1 interface.

At step 2, the DU 604 may transmit the energy saving capability of the RU 606 to the SMO/Non-RT RIC 602 in the similar manner as described above in relation to operation S520. The energy saving capability of the RU 606 may be transmitted via, for example, the O1 interface.

At step 3, the SMO/Non-RT RIC 602 may select a value from within a capability range indicated in the energy saving capability of the RU 606 in the similar manner as described above in relation to operation S530.

At step 4, the SMO/Non-RT RIC 602 may transmit the selected value to the DU 604 in the similar manner as described above in relation to operation S540. The selected value may be transmitted via, for example, the O1 interface.

At step 5, once the DU 604 receives the selected value from the SMO/Non-RT RIC 602 (which is associated with at least one of: a sleep mode of a plurality of sleep modes and an array mode of a plurality of array modes), the DU 604 may determine the at least one of: the sleep mode of the plurality of sleep modes and the array mode of the plurality of array modes associated with the selected value, and then execute such determined at least one of: the sleep mode of the plurality of sleep modes and the array mode of the plurality of array modes.

For example, the DU 604 may receive value 3 from the SMO/Non-RT RIC 602, and determine which energy saving feature(s) is associated with value 3. Accordingly, the DU 604 may determine that SM2 and first array mode are associated with the value 3, and then execute the SM2 and first array mode.

At step 6, the DU 604 may transmit command associated with the executed energy saving feature to the RU 606. For example, the DU 604 may transmit command for the RU 606 to disable the RF processing unit and the digital processing unit of the RU 606 for the second duration (i.e., SM2), and a command for the RU 606 to disable the first group of antenna elements (change the configuration of the antenna arrays of the RU 606 from the baseline configuration to the configuration where all antenna elements of the RU 606 except the first group of antenna elements are enabled) (i.e., first array mode). The command associated with the executed energy saving feature may be transmitted via, for example, a front haul plane message, such as a Section Type 4 (ST4) C-Plane message.

It can be understood that the configuration illustrated in FIG. 6 is provided for descriptive purpose, and is not intended to limit the scope of the present disclosure in any way. In particular, the SMO/Non-RT RIC 602 may be replaced with a Near-RT RIC (where the communications with the DU 604 and RU 606 may be done via an E2 interface), the number of DU 604 and RU 606 may be any number, and the communications between the SMO/Non-RT RIC 602, DU 604, and RU 606 may be performed via other suitable interface in with different configuration (e.g., SMO/Non-RT RIC 602 may communicate with the DU 604 and RU 606 via the Near-RT RIC and A1 and E2 interfaces, and the like).

FIG. 7 illustrates a flow diagram of an example method 700 for performing energy saving control, according to one or more embodiments. One or more operations in method 700 may be performed by the apparatus of one or more example embodiments of the present disclosure. The apparatus may be configured to perform energy saving control.

According to example embodiments, the apparatus may include an SMO, a Non-RT RIC, or a Near-RT RIC, where the Non-RT RIC may be communicatively coupled to the Near-RT RIC via an A1 interface.

As illustrated in FIG. 7, at operation S710, the apparatus may be configured to transmit an energy saving capability request. The energy saving capability request may be transmitted to a distributed unit (DU), and may specify a request for the DU to transmit an energy saving capability of a radio unit (RU) associated with the DU in the similar manner as described above in relation to operation S510 in method 500. The method then proceeds to operation S720.

At operation S720, the apparatus may be configured to receive the energy saving capability of the RU associated with the DU. The energy saving capability may be received from the DU, and may specify energy saving features that are supported (i.e., can be performed) by the RU in the similar manner as described above in relation to operation S520 in method 500. The method then proceeds to operation S730.

At operation S730, the apparatus may be configured to determine an allowed energy saving feature. The allowed energy saving feature may specify an energy saving feature that is allowed to be executed by the DU. According to example embodiments, the allowed energy saving feature may include a sleep mode from the plurality of sleep modes (i.e., plurality of sleep modes supported by the RU and indicated in the energy saving capability), an array mode from the plurality of array modes (i.e., plurality of array modes supported by the RU and indicated in the energy saving capability), or a combination of a sleep mode from the plurality of sleep modes and an array mode from the plurality of array modes. For example, the apparatus may determine that the DU is allowed to execute only SM1, first array mode, and second array mode.

According to example embodiments, the allowed energy saving feature may be associated with a trigger condition, and may specify an energy saving feature that is allowed to be executed by the DU based on the trigger condition. The trigger condition may include any conditions associated with the performance, status, operations, and the like of the network. For example, the trigger condition may include at least one of: Physical Resource Block (PRB) usage, number of connected User Equipment (UE), Packet Data Convergence Protocol (PDCP) buffer, QoS target, energy consumption of the RU, user distribution, user RF coverage, coverage of underlying cells, and the like exceeding a threshold; where SM1 may be associated with the PRB usage exceeding a first threshold, first array mode may be associated with number of connected UE exceeding a second threshold, and second array mode may be associated with PDCP buffer exceeding a third threshold.

According to example embodiments, the allowed energy saving feature may not be associated with a trigger condition. In particular, for example, a sleep mode with low/short latency (e.g., few symbols or slots) may have minimum impact on the user experience, while a sleep mode with high/long latency may have large impact on the user experience. Accordingly, the allowed energy saving feature may include the low latency sleep mode and high latency sleep mode, where the low latency sleep mode may not be associated with a trigger condition, while the high latency sleep mode may be associated with a trigger condition (i.e., only triggers during a specific situation).

The apparatus may determine the allowed energy saving feature and the associated trigger condition using any means. According to example embodiments, the apparatus may determine the allowed energy saving feature and the associated trigger condition using an AI/ML model trained based on historical records of a performance of the network (e.g., traffic load, energy saving efficiency measurements, Key Performance Indicators (KPIs), and the like). Accordingly, according to example embodiments, the apparatus may be configured to also monitor the performance of the network, as well as train the AI/ML model based on historical records of the performance. It may be understood that energy saving related KPI metric may be identified according to different Work Groups (WG) of the O-RAN Alliance. For example, WG4 may identify energy saving related KPI metrics for RU, WG5 may identify energy saving related KPI metrics for CU and DU, and WG6 may identify energy saving related KPI metrics for the O-Cloud.

The method then proceeds to operation S740.

At operation S740, the apparatus may be configured to transmit the determined allowed energy saving feature. The determined allowed energy saving feature may be transmitted to the DU, such that the DU may execute the allowed energy saving feature based on the trigger condition. For example, the DU may monitor the PDCP buffer, and execute the second array mode when the PDCP buffer exceeds the third threshold.

According to example embodiments, the determined allowed energy saving feature may be transmitted to the DU via an O1 interface, such that the energy saving features may be triggered through the O1 interface to the RU via the DU. According to example embodiments, the determined allowed energy saving feature may be transmitted to the DU along with a request to trigger an energy saving feature. According to example embodiments, the DU may analyze the request and the determined allowed energy saving feature in order to determine which energy saving feature to execute for which trigger condition.

According to example embodiments, the determined allowed energy saving feature may be executed by the DU via a C-Plane message in the fronthaul. According to example embodiments, the determined allowed energy saving feature may be executed by the DU via a Section Type 4 (ST4) C-Plane message.

According to example embodiments, the ST4 C-Plane message may be used to specify (send) slot level configuration from the DU to the RU, which may apply to one or more endpoints in the RU (i.e., all endpoints belonging to a carrier, all endpoints associated with a tx-array/rx-array, all the endpoints in the RU, and the like). According to example embodiments, the slot level configuration may be specified for multiple extended antenna-carrier identifiers (eAxC IDs) with one or more ST4 configuration commands.

According to example embodiments, the ST4 configuration commands may include a TRX control command, which may be defined to allow energy saving by disabling (putting to sleep) one or more antenna elements in an antenna array of the RU (e.g., tx array, rx-array, and the like). According to example embodiments, the TRX control command may include an antenna mask parameter specifying a specific antenna element that is to be disabled or enabled. For example, the antenna mask parameter may specify a value “0” for antenna elements to be disabled, and a value “1” for antenna elements to be enabled.

According to example embodiments, the ST4 configuration commands may include an ASM command, which may be defined to allow energy saving by disabling (putting to sleep) one or more components of the RU for a duration of time in order to reduce some or an entire processing of the RU. According to example embodiments, when the ASM command pertains to an antenna array, the ASM command may pertain to all antenna elements in the array (e.g., all antenna elements in the tx-array, rx array, and the like). According to example embodiments, the ASM command may include a sleep mode parameter specifying a specific sleep mode. According to example embodiments, the sleep mode parameter may specify a maximum number of sleep modes (e.g., 4 sleep modes) which are based on a wake-up duration.

According to example embodiments, the ST4 C-Plane message may specify a time duration for activating the energy saving features. According to example embodiments, the ST4 C-Plane message may include a “numSlots” parameter and “numSlotsExt” parameter to specify a time duration (slot) for activating the energy saving features. According to example embodiments, the “numSlots” parameter and “numSlotsExt” parameter may be set to zero in order to activate the energy saving features for longer or for undefined duration.

According to example embodiments, the ST4 C-Plane message may also specify a command scope, which may include at least one of CARRIER-COMMAND, ARRAY-COMMAND, and O-RU-COMMAND.

According to example embodiments, the DU may use the ST4 C-Plane message to apply a sleep mode/array mode to the RU (i.e., apply configurations associated with a sleep mode/array mode to the RU), where the RU may then apply the sleep mode/array mode using the ST4 C-Plane message. According to example embodiments, the DU may use the ST4 C-Plane message together with a Section Extension (e.g., SE 10 messages, SE 11 messages, SE 16 messages, SE 19 messages, and the like).

According to example embodiments, the apparatus may also be configured to receive a performance counter. The performance counter may be measured by and received from the DU in the similar manner as described above in relation to method 500.

Upon performing operation S740, the method 700 may be ended or be terminated. Alternatively, method 700 may return to operation S710, such that the apparatus may be configured to repeatedly perform, for at least a predetermined amount of time, the transmitting the energy saving capability request (at operation S710), the receiving the energy saving capability (at operation S720), the determining the allowed energy saving feature (at operation S730), and the transmitting the determined allowed energy saving feature (at operation S740).

In view of the above, example embodiments of the present disclosure allow for energy saving features to be effectively controlled and provisioned to the RU, while considering the capability of the RU and the various conditions of the network.

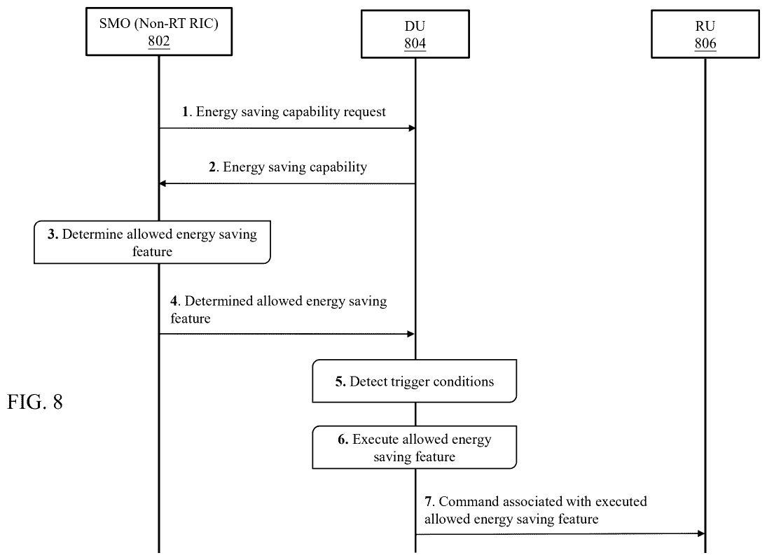

FIG. 8 illustrates a flow sequence of an example use case for performing energy saving control, according to one or more embodiments. As shown in FIG. 8, the flow sequence may involve an SMO/Non-RT RIC 802, DU 804, and RU 806. The SMO/Non-RT RIC 802, DU 804, and RU 806 may be similar to the SMO 110, Non-RT RIC 120, O-DU 170, and O-RU 180 described above in relation to FIG. 1. Further, one or more operations in FIG. 8 may involve or may be part of one or more operations described above with reference to FIG. 7. For instance, steps 1 to 4 in FIG. 8 may be similar to operations S710 to S740 in FIG. 7, respectively.

At step 1, the SMO/Non-RT RIC 802 may transmit a data collection request to the DU 804 in the similar manner as described above in relation to operation S710. The data collection request may be transmitted via, for example, an O1 interface.

At step 2, the DU 804 may transmit the energy saving capability of the RU 806 to the SMO/Non-RT RIC 802 in the similar manner as described above in relation to operation S720. The energy saving capability of the RU 806 may be transmitted via, for example, the O1 interface.

At step 3, the SMO/Non-RT RIC 802 may determine the allowed energy saving feature in the similar manner as described above in relation to operation S730.

At step 4, the SMO/Non-RT RIC 802 may transmit the determined allowed energy saving feature to the DU 804 in the similar manner as described above in relation to operation S740. The determined allowed energy saving feature may be transmitted via, for example, the O1 interface.

At step 5, once the DU 804 receives the determined allowed energy saving feature from the SMO/Non-RT RIC 802, the DU 804 may monitor the performance, status, operations, and the like of the network, and detect the trigger condition(s) associated with the allowed energy saving feature. For example, the DU 804 may detect the PDCP buffer exceeding the third threshold.

At step 6, the DU 804 may execute the allowed energy saving feature associated with the detected trigger condition. For example, the DU 804 may execute the second array mode associated with the PDCP buffer exceeding the third threshold.

At step 7, the DU 804 may transmit command associated with the executed allowed energy saving feature to the RU 806. For example, the DU 804 may transmit command for the RU 806 to disable the second group of antenna elements (change the configuration of the antenna arrays of the RU 806 from the baseline configuration to the configuration where all antenna elements of the RU 806 except the second group of antenna elements are enabled) (i.e., second array mode). The command associated with the executed allowed energy saving feature may be transmitted via, for example, a front haul plane message, such as a Section Type 4 (ST4) C-Plane message.

It can be understood that the configuration illustrated in FIG. 8 is provided for descriptive purpose, and is not intended to limit the scope of the present disclosure in any way. In particular, the SMO/Non-RT RIC 802 may be replaced with a Near-RT RIC (where the communications with the DU 804 and RU 806 may be done via an E2 interface), the number of DU 804 and RU 806 may be any number, and the communications between the SMO/Non-RT RIC 802, DU 804, and RU 806 may be performed via other suitable interface (e.g., SMO/Non-RT RIC 802 may communicate with the DU 804 and RU 806 via the Near-RT RIC and A1 and E2 interfaces, and the like).

In view of the above, example embodiments of the present disclosure allow for energy saving features to be effectively controlled and provisioned to the RU, while considering various essential aspects, such as the capability of the RU, the tradeoff between user experience and energy saving performance, and the various conditions of the network.

For example, example embodiments of the present disclosure allow for controlling of dynamic switching of SSB periodicity while providing minimum and maximum values, and traffic shifting from capacity carrier to coverage carrier by the Near-RT RIC via the A1 and E2 interfaces in order to optimize energy efficiency and consumption.

Further, example embodiments of the present disclosure allow for controlling of ASM operations. For example, Near-RT RIC may be allowed to control the sleep modes which have wake-up time higher than 10 ms (in certain embodiments, RU may only provide wake-up time, where the DU may send the RU to sleep with specific sleep modes for a certain duration of time), Near-RT RIC may be allowed to execute the sleep modes on the RU through the DU's CUS-Plane, individual sleep modes may be modified to be shortened and/or elongated, the above configuration may be used to determine if a cell will be transmitting SSB and/or Physical Random Access Channel (PRACH), allowed period of maximum sleep may be specified in milliseconds, and SSB periodicity parameters may be utilized by interfacing with CU for Radio Resource Control (RRC)/Master Information Block (MIB)/System Information Block (SIB) modifications.

Furthermore, example embodiments of the present disclosure allow for controlling of TRX control operations. For example, Near-RT RIC may be allowed to control the TRX at latency higher than 10 ms, Near-RT RIC/Non-RT RIC may be allowed to execute the control of turning off/on the antenna elements of the RU through the DU's CUS-Plane. and SSB periodicity parameters may be utilized by interfacing with CU for Radio Resource Control (RRC)/Master Information Block (MIB)/System Information Block (SIB) modifications. According to example embodiments, the DU may reject E2 or O1 command from the Near RT-RIC and Non-RT RIC due to its own internal logic (e.g., emergency call running, users to be affected, and the like). In such case, analysis on user distribution, underlying coverage from other cells, impact on the users, and the like, may be done in the Near RT-RIC or Non-RT RIC.

Additionally, since not every operator can have access to a Near-RT RIC, Non-RT RIC may be utilized which allows for reusing of O1 interface parameters and mode. On the other hand, if O1 interface is not used, implementations may be done via E2 interface and Near-RT RIC. Further, O1 interface may also be utilized for NES use case scenarios and transmission of associated parameters, for exposing capabilities of the DU (as well as RU) against each NES use case, for read and configuration of energy saving control parameters by the SMO, for allowing the SMO to subscribe and receive notifications related to changes to energy saving control attributes, and for collection and reporting of performance measurement data.

According to example embodiments, the roles and responsibilities of a Non-RT RIC, Near-RT RIC, DU, and RU may be defined below. It can be understood that the below explanations are provided for descriptive purpose, and is not intended to limit the scope of the present disclosure in any way. In particular, the roles and responsibilities for each of the Non-RT RIC, Near-RT RIC, DU, and RU may be switched, combined, and added and/or removed from the example provided without departing from the scope of the present disclosure.

According to example embodiments, the Non-RT RIC may be responsible for obtaining the capability of RU and DU to support ASM and TRX control; monitoring energy consumption of the system/apparatus; generating AI/ML model through utilizing all relevant user and Energy Performance Counters/KPIs; providing A1 policy guidance to Near-RT RIC on EE and EC; generating O1 based policy/configuration parameters for the DU; providing policy on which cells or RU can be utilized for ASM or TRX control; providing goals of energy savings or user/cell experience on a particular area; and controlling TRX directly through direct control commands to DU or provide a policy for TRX control to DU.

According to example embodiments, the Near-RT RIC may be responsible for monitoring energy consumption of the RUs; QoS monitoring of users (latency and throughput); cell level EE and performance KPIs; current traffic load and prediction on all carrier in a particular area; generating ASM policy/guidance or exact sleep commands for DU/CU based on A1 policy; providing feedback to Non-RT RIC on A1 Policy execution; initiating energy savings policy; inquiring about DU and RU capabilities; providing initial value of ES and increase the value over time to learn about impact on users and energy consumption reduction; changing the knob if user performance degradation is acceptable (based on A1 policy); activating Intelligent Scheduling features including slots and symbols (for level 1 DU only); and controlling TRX directly through direct control commands to DU or provide a policy for TRX control to DU.

According to example embodiments, the DU may be responsible for intelligence traffic shaping for energy savings; data convergence in symbols; data convergence in slots; controlling and executing ASM on RU in real time via Open Front Haul CUS-Plane based on RU capabilities; interpreting Near-RT RIC provided EE policy and execute ASMs as per the policy; exposing DU's ASM related capabilities to Near-RT RIC; exposing capabilities related to Intelligent Scheduling for EE Optimization; exposing Du and RU capabilities on TRX control to Near-RT RIC or Non-RT RIC; providing knob for controlling energy savings through ASM or TRX control by Near-RT RIC or Non-RT RIC; and providing the ability to shutdown antenna of the RU when received E2SM direct command or policy from Near-RT RIC.

According to example embodiments, the RU may be responsible for sharing RU ASM and TRX capabilities to DU via M-Plane; and executing ASM or TRX control based on DU C-Plane commands over FH.

### Various Aspects of Embodiments

Example embodiments of the present disclosure allow for energy saving features to be effectively controlled and provisioned to the RU, while considering various essential aspects, such as the capability of the RU, the tradeoff between user experience and energy saving performance, and the various conditions of the network

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

One or more components of the system of the example embodiments (e.g., Non-RT RIC, Near-RT RIC, etc.), as well as the operations associated therewith (e.g., one or more operations in FIG. 5 to FIG. 8, etc.), may be implemented in one or more systems, devices, or hardware components, such as one or more servers, and the like. In the following, descriptions of a device in which the systems or components of the example embodiments may be implemented are provided. It is contemplated that one or more operations or methods described above with reference to FIG. 5 to FIG. 8 may be performed by the device. For instance, the one or more operations or methods may be performed by at least one processor of the device upon executing machine-readable instructions or computer-readable instructions (e.g., instructions for implementing the Non-RT RIC, etc.) stored in a memory or a storage component of the device.

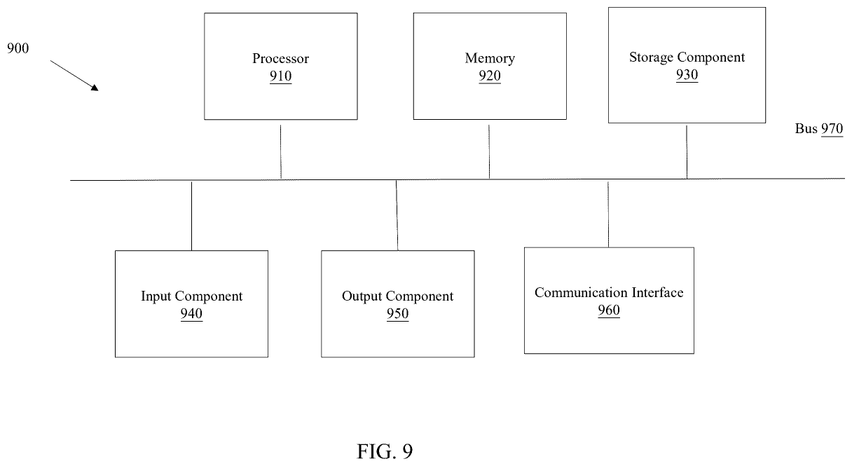

FIG. 9 illustrates a diagram of example components of a device 900 for implementing one or more example embodiments. As shown in FIG. 9, the device 900 includes a processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and one or more single core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 causes the processor 910 to perform one or more method steps of an embodiment described herein.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, an instruction device to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of device 900 in communication with one another.

Various further respective aspects and features of embodiments of the present disclosure may be defined by the following items:
Item [1]: An apparatus that may be configured to: transmit an energy saving capability request to a distributed unit (DU); receive, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; select a value within the capability range; and transmit the selected value to the DU.
Item [2]: The apparatus according to item [1], wherein: each value within the capability range may be associated with at least one of: a sleep mode of the plurality of sleep modes and an array mode of the plurality of array modes; and the selected value within the capability range may be associated with at least one of: a sleep mode of the plurality of sleep modes and an array mode of the plurality of array modes to be executed by the DU.
Item [3]: The apparatus according to item [2], wherein the at least one of: the sleep mode of the plurality of sleep modes and the array mode of the plurality of array modes associated with the selected value may be executed by the DU via a Section Type 4 (ST4) C-Plane message.
Item [4]: The apparatus according to one of items [1]-[3], wherein the capability range may include a range of values from a first value representing a maximum user experience and a minimum energy saving performance of the RU to a second value representing a minimum user experience and a maximum energy saving performance of the RU.
Item [5]: The apparatus according to one of items [1]-[4], wherein each of the plurality of sleep modes may be associated with a component of the RU and a sleep duration, and wherein the sleep duration may include a duration when the associated component of the RU is disabled.
Item [6]: The apparatus according to one of items [1]-[5], wherein each of the plurality of array modes may be associated with an antenna element of the RU to disable.
Item [7]: The apparatus according to one of items [1]-[6], wherein the apparatus may be configured to select the value within the capability range using an Artificial Intelligence (AI)/Machine Learning (ML) model.
Item [8]: A method that may include: transmitting an energy saving capability request to a distributed unit (DU); receiving, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; selecting a value within the capability range; and transmitting the selected value to the DU.
Item [9]: The method according to item [8], wherein: each value within the capability range may be associated with at least one of: a sleep mode of the plurality of sleep modes and an array mode of the plurality of array modes; and the selected value within the capability range may be associated with at least one of: a sleep mode of the plurality of sleep modes and an array mode of the plurality of array modes to be executed by the DU.
Item [10]: The method according to item [9], wherein the at least one of: the sleep mode of the plurality of sleep modes and the array mode of the plurality of array modes associated with the selected value may be executed by the DU via a Section Type 4 (ST4) C-Plane message.
Item [11]: The method according to one of items [8]-[10], wherein the capability range may include a range of values from a first value representing a maximum user experience and a minimum energy saving performance of the RU to a second value representing a minimum user experience and a maximum energy saving performance of the RU.
Item [12]: The method according to one of items [8]-[11], wherein each of the plurality of sleep modes may be associated with a component of the RU and a sleep duration, and wherein the sleep duration may include a duration when the associated component of the RU is disabled.
Item [13]: The method according to one of items [8]-[12], wherein each of the plurality of array modes may be associated with an antenna element of the RU to disable.
Item [14]: The method according to one of items [8]-[13], wherein the value within the capability range may be selected using an Artificial Intelligence (AI)/Machine Learning (ML) model.
Item [15]: A non-transitory computer-readable recording medium that may have recorded thereon instructions executable by an apparatus to cause the apparatus to perform a method including: transmitting an energy saving capability request to a distributed unit (DU); receiving, from the DU, an energy saving capability of a radio unit (RU) associated with the DU, wherein the energy saving capability may include at least one of: a plurality of sleep modes of an Advanced Sleep Mode (ASM) and a plurality of array modes of an antenna mask (TRX) control that can be performed by the RU, and wherein the energy saving capability may further include a capability range associated with the at least one of: the plurality of sleep modes and the plurality of array modes; selecting a value within the capability range; and transmitting the selected value to the DU.
Item [16]: The non-transitory computer-readable recording medium according to item [15], wherein: each value within the capability range may be associated with at least one of: a sleep mode of the plurality of sleep modes and an array mode of the plurality of array modes; and the selected value within the capability range may be associated with at least one of: a sleep mode of the plurality of sleep modes and an array mode of the plurality of array modes to be executed by the DU.
Item [17]: The non-transitory computer-readable recording medium according to item [16], wherein the at least one of: the sleep mode of the plurality of sleep modes and the array mode of the plurality of array modes associated with the selected value may be executed by the DU via a Section Type 4 (ST4) C-Plane message.
Item [18]: The non-transitory computer-readable recording medium according to one of items [15]-[17], wherein the capability range may include a range of values from a first value representing a maximum user experience and a minimum energy saving performance of the RU to a second value representing a minimum user experience and a maximum energy saving performance of the RU.
Item [19]: The non-transitory computer-readable recording medium according to one of items [15]-[18], wherein each of the plurality of sleep modes may be associated with a component of the RU and a sleep duration, and wherein the sleep duration may include a duration when the associated component of the RU is disabled.
Item [20]: The non-transitory computer-readable recording medium according to one of items [15]-[19], wherein each of the plurality of array modes may be associated with an antenna element of the RU to disable.

It can be understood that numerous modifications and variations of the present disclosure are possible in light of the above teachings. It will be apparent that within the scope of the appended clauses, the present disclosures may be practiced otherwise than as specifically described herein.

### Additional Descriptions

Advance Sleep Mode Related Configuration policy from Near RT RIC to O-DU/O-CU.

### Policy Provisioning (Knob Based)

Option 1: O-DU report its energy savings capability of O-RU through a Knob for example a range [1 to 5]
Value 1=Maximize user experience & Value 5=Maximize Energy Savings.
Near RT RIC or Non-RT RIC can dynamically change the value based on the user experience vs the energy savings or energy consumption.
Along, with the Knob RIC Can also provide following
   Min QoS Target (User PDCP Latency, Throughput).
   Target O-RU Energy Consumption
Aggressive target means DU schedule compress more user's data into TTIs.
Dynamic SSB Periodicity (Switch); Provide minimum and maximum range.
A1->E2 (Near-RT RIC) Traffic Shift from Capacity Carrier to Coverage Carrier to Optimise Energy Efficiency and Consumption.

### Policy Provisioning (Allowed Sleep Modes)

Option 2: Near RT RIC provide guidance on which supported Sleep modes can be supported. (if only Low Latency Sleep Modes, for exampled few Symbols or Slots are allowed to turn on then Impact on user experience will be minimum). However, when longer sleep modes are enabled by near-RT RIC for O-DU then O-DU executes the sleep modes under specific conditions.

Conditions=PRB Usage for a Time Period, lower then a certain threshold; Number of Connected UE's in Cell under certain threshold; PDCP Buffer of all user under a threshold. (Delay).
Along, with the sleep modes that can be utilized by O-DU/o
   Min QoS Target (User PDCP Latency, Throughput).
   Target O-RU Energy Consumption
Aggressive target means DU schedule compress more user's data into TTIs.
Dynamic SSB Periodicity (Switch)->RIC Provide minimum and maximum range.
A1->E2 (Near-RT RIC) Traffic Shift from Capacity Carrier to Coverage Carrier to Optimise Energy Efficiency and Consumption.

Advance Sleep Mode Related Configuration Parameters from Near RT RIC to O-DU/O-CU.

### Control Individual Sleep Mode.

Near RT RIC Control of Individual Sleep Modes On/Off Control
   Near RT RIC can control the sleep modes which have Wake Up time higher then 10 ms.
   Near RT RIC will execute The sleep mode on O-RU Through O-DU CUS-Plane.
   Individual Sleep Modes Shorten/Elongate (Based on latency and other user experience KPIs′)
   Note: O-RU only provide Wake up time for each O-RU, it is upto O-DU to send the O-RU to sleep with specific Sleep Mode and for certain period of time.
      During Certain period of time shorter sleep modes can be elongated by provide definite sleep for longer periods at a time.
      Above configuration can also be used to determine if the cell will be transmitting SSB and PRACH.
      Allowed period of Maximum Sleep-in milliseconds.
      SSB Periodicity Parameter—May require interface with O-CU for RRC/MIB/SIB Modifications.

TRX Control Related Configuration policy from Near RT RIC to O-DU/O-CU.

### Policy Provisioning (Knob Based)

Option 1: O-DU report its energy savings capability of O-RU through a Knob for example a range [1 to 5]
Value 1=Maximize user experience & Value 5=Maximize Energy Savings.
Near RT RIC or Non-RT RIC can dynamically change the value based on the user experience vs the energy savings or energy consumption.
Along, with the Knob RIC Can also provide following
   Min QoS Target (User PDCP Latency, Throughput).
   Target O-RU Energy Consumption

### Policy Provisioning (Allowed TRX/Antenna Control)

Option 2: Near RT RIC provide guidance on which Antennas can be turned off/On. For example for Massive MIMO, TRX Control is allowed from 64T64R to 32T32R. Or for non Massive MIMO O-RU, 4T4R to 2T2R.

### Conditions

Impact on users, take action when impact on users is minimum
   Min QoS Target (User PDCP Latency, Throughput).
   Target O-RU Energy Consumption
Based on User distribution, Users RF Coverage, Coverage of other underlying cells, -RIC can guide O-DU to disable or enable certain Antenna elements or set of antenna elements.

TRX Control Related Configuration Parameters from Near RT RIC to O-DU/O-CU.

Control Individual Antenna Elements/TRX or set of Antenna elements.
Near RT RIC or Non-RT RIC command O-DU to turn on/Off Certain Antenna Elements
   Near RT RIC can control the TRX at latency above 10 ms
   Near RT RIC/Non-RT will execute the control of turning off or On of O-RU Through O-DU CUS-Plane . . .
      O-DU may reject the E2SM or O1 command from near RT RIC or Non-RT RIC due to its own internal logic (emergency call running, users to be effected etc.)
      In this scenario most of the analysis on user distribution, underlying coverage from other cells and impact on users would be done in the near RT or Non RT RIC.
      SSB Periodicity Parameter—May require interface with O-CU for RRC/MIB/SIB Modifications.

Advance sleep modes and TRX Control Roles and Responsibilities.

### Non-RT RIC

Get the capability of O-RU's and O-DU to support Advance Sleep modes and TRX Control
Monitor Energy consumption of System.
Generate ML Model through utilizing all relevant User and Energy Performance Counters/KPIs
Opt 1: Provide A1 Policy guidance to Near RT RIC on EE and EC.
Opt 2: Generate O1 based Policy/Configuration Parameters for O-DU.
Provide policy on which cells or O-RU can be utilized for ASM or TRX sleep.
Provide goals of energy savings or user/cell experience or a particular area.
Control TRX directly through direct control commands to O-DU or Provide a policy for TRX control to O-DU.

### Near-RT RIC

Monitor Energy consumption of O-RUs
QoS Monitoring of Users (Latency and Throughput)
Cell Level EE and Performance KPIs.
Current Traffic Load and prediction on all carrier in a particular area.
Generate Advance sleep modes Policy/Guidance or Exact Sleep commands for O-DU/O-CU based on A1 Policy.
Feedback to Non-RT RIC on A1 Policy execution.
Initiate Energy savings Policy, Inquire about O-DU & O-RU Capabilities
Provide initial value of ES and increase the value over time to learn about
Impact on users and energy consumption reduction.
Change the Knob if user performance degradation is acceptable (Based on A1 Policy)
For O-DU (Level 1, O-DU Only activates Intelligent Scheduling features including Slot and symbols).
Control TRX directly through direct control commands to O-DU or Provide a policy for TRX control to O-DU.

### O-DU

Intelligent Traffic shaping for energy savings
Data Convergence in Symbols
Data Convergence in Slots.
Based on O-RU Capabilities Control and Execute Advance sleep modes on O-RU in Real time via Open Front Haul CUS-Plane.
Interpret Near-RT RIC Provided EE Policy and execute ASMs as per the policy.
Expose O-DU's ASM related Capabilities to Near RT RIC.
Also, Expose capabilities related to Intelligent Scheduling for EE Optimization.
Expose O-DU and O-RU's Capabilities on TRX control to Near RT or Non-RT RIC.
Provide Knob for controlling energy savings through Advance sleep modes or TRX Control by Near RT or Non-RT RIC.
Ability to shutdown Antenna's of O-RU when received E2SM direct command or Policy from near RT RIC.

### O-RU.

Share O-RU ASM and TRX Capabilities to O-DU via M-Plane.
Based on O-DU C-Plane commands over FH execute advance sleep modes or TRX Turn On/Off.

Counters required for Energy savings features.

| | WG4 | WG5 (O-DU Calculates/Count and Report |
|---|---|---|
| Energy Saving Method | (Fronthaul) | via O1 or E2) |
| Carrier Cell | OR.ORU.EPE-STATS | Number of times Carrier Cell |
| Switch On/Off | | Switch On/Off |
| | | Sum of Seconds when Carrier/Cell |
| | | was in energy savings mode. |
| RF Channel Switch | OR.ORU.EPE-STATS | Number of Times Each TRX |
| On/Off TRX | | Configuration is executed (during a |
| Control | | ROP) |
| | | & |
| | | Total Time for each configuration |
| | | (during a ROP) |
| | | Times each energy savings KNOB |
| | | TRX Control is utilized |
| | | Count of Times and total time |
| | | (seconds) Each ASM with TRX |
| | | control was executed on O-RU) |
| RF Channel Switch | OR.ORU.EPE-STATS | Number of Times O-DU restricted |
| On/Off | | O-RU to lower Layer Mode |
| Layer Control | | (Specific number of Layers) (during |
| | | a ROP) |
| | | & |
| | | Total Time for each configuration |
| | | (during a ROP) |
| Advanced Sleep Mode | OR.ORU.EPE-STATS | Number of Times O-DU sent O-RU |
| | | to a particular advance sleep mode. |
| | | & |
| | | Total Time for each configuration |
| | | (during a ROP) |
| | | Times each energy savings KNOB |
| | | for Advance sleep modes is utilized |

| | WG3 | WG2 |
|---|---|---|
| Energy Saving Method | (E2SM KPM - E2 AP) | (A1 TD or R1 TD) |
| Carrier Cell Switch On/Off | KPM define Cell/Carrier | Energy Consumption of O-RU |
| | configuration for Energy | Number of times Carrier/Cell |
| | Savings Mode | Shutdown due to ES |
| | Energy Consumption | Number of Times O-RU |
| | | configuration changed to O-RU |
| | | Hardware Energy savings Mode |
| RF Channel Switch On/Off | E2SM KPM Definition | O1 Definition for Energy Savings |
| TRX Control | for Energy Savings | Number of times O-RU is Power |
| | Number of times O-RU is | Saving mode through TRX |
| | Power Saving mode | Control |
| | through TRX Control | Total time in each ES TRX |
| | Total time in each ES | configuration |
| | configuration | Total energy consumption of |
| | Times each energy | O-RU or cell |
| | savings KNOB TRX | |
| | Control is utilized | |
| | Total energy consumption | |
| | of O-RU or cell | |
| RF Channel Switch On/Off | E2SM KPM Definition | A1 TD/R1 TD Definition for |
| Layer Control | for Energy Savings | Energy Savings |
| | Number of times O-RU is | Number of times O-RU is in |
| | in particular Power | particular Power Saving mode |
| | Saving mode through | through Layer Control |
| | Layer Control | Total time in each ES |
| | Total time in each ES | configuration |
| | configuration | Total energy consumption of |
| | | O-RU or cell |
| Advanced Sleep Mode | E2SM KPM Definition | A1 TD/R1 TD Definition for |
| | for Energy Savings | Energy Savings |
| | Number of times O-RU is | Number of times O-RU is in |
| | in particular Sleep Mode | particular Power Saving mode |
| | Total time in each ES | through Sleep modes |
| | configuration | Total time in each Sleep Mode |
| | Total energy consumption | configuration |
| | of O-RU or cell | Total energy consumption of |
| | | O-RU or cell |

NES related O-RU performance counters (TRx Control)—WG5.

TABLE B.1-1
Counters definition

| Measurement- | measurement- | report- | | |
|---|---|---|---|---|
| group | object | info | object-unit | Note |
| nes- | TRX_CONTROL_{—} | count | RU, | Type yang: counter64 is used for the |
| measurement- | CONFIG_X_TIME | | TRANSPORT, | count. When object-unit is EAXC_ID, |
| objects | | | OR EAXC_ID | TRANSPORT is reported as additional |
| | | | | parameter for EAXC_ID. |
| | TRX_CONTROL_{—} | count | RU, | Type yang: counter64 is used for the |
| | CONFIG_{—} | | TRANSPORT, | count. When object-unit is EAXC_ID, |
| | TRANSITION_{—} | | OR EAXC_ID | TRANSPORT is reported as additional |
| | TIME | | | parameter for EAXC_ID. |
| | TRX_CONTROL_{—} | max | Hardware | Type decimal64 including 4 fraction- |
| | CONFIG_X_{—} | min | component | digits for max, min, average. Power |
| | POWER | average | type e.g., | measured using method specified in |
| | | | O-RAN-RADIO, | clause 5.1.1.19 of 3GPP TS 28.552 [57] |
| | | | O-RU-POWER- | Unit of power: watts (W) Temperature |
| | | | AMPLIFIER, | measured using method specified in |
| | | | O-RU-FPGA, | clause 5.1.1.19 of 3GPP TS 28.552 [57] |
| | | | power-supply, | Unit of temperature: Celsius Voltage |
| | | | fan, cpu | measured using method as specified in |
| | | | | clause 5.1.1.19 of 3GPP TS 28.552 [57] |
| | | | | Unit of voltage: Volts Current measured |
| | | | | using method specified in clause |
| | | | | 5.1.1.19 of 3GPP TS 28.552 [57] Unit of |
| | | | | current: Ampere. |

NES related O-RU performance counters (ASM)—WG4 (Contd . . . ).

TABLE B.1-1
Counters definition

| Measurement- | measurement- | report- | | |
|---|---|---|---|---|
| group | object | info | object-unit | Note |
| nes- | ASM_MODE_{—} | count | RU, | Type yang: counter64 is used for the |
| measurement- | X_TIME | | TRANSPORT, | count. When object-unit is EAXC_ID, |
| objects | | | OR EAXC_ID | TRANSPORT is reported as additional |
| | | | | parameter for EAXC_ID. |
| | ASM_MODE_{—} | count | RU, | Type yang: counter64 is used for the |
| | WAKE_UP_{—} | | TRANSPORT, | count. When object-unit is EAXC_ID, |
| | TIME | | OR EAXC_ID | TRANSPORT is reported as additional |
| | | | | parameter for EAXC_ID. |
| | ASM_MODE_{—} | max | Hardware | Type decimal64 including 4 fraction- |
| | X_POWER | min | component | digits for max, min, average. Power |
| | | average | type e.g., | measured using method specified in |
| | | | O-RAN-RADIO, | clause 5.1.1.19 of 3GPP TS 28.552 [57] |
| | | | O-RU-POWER- | Unit of power: watts (W) Temperature |
| | | | AMPLIFIER, | measured using method specified in |
| | | | O-RU-FPGA, | clause 5.1.1.19 of 3GPP TS 28.552 [57] |
| | | | power-supply, | Unit of temperature: Celsius Voltage |
| | | | fan, cpu | measured using method as specified in |
| | | | | clause 5.1.1.19 of 3GPP TS 28.552 [57] |
| | | | | Unit of voltage: Volts Current measured |
| | | | | using method specified in clause |
| | | | | 5.1.1.19 of 3GPP TS 28.552 [57] Unit of |
| | | | | current: Ampere. |

WG5—NES Performance counters Example.

A.14.1 Performance Counter Table

| | |
|---|---|
| Measurement Name | OR.ORU.EPE-STATS |
| Description | The epe-stats include the performance measurement |
| | for energy, power and environmental parameters. |
| | This counter would be useful to quantify the energy |
| | saving achieved |
| Collection Method | CC (Cumulative Counter) |
| Condition | TRx control/ASM |
| Measurement Result | Energy saving related performance counters |
| Measurement Type | OR.ORU.EPE-STATS |
| Measurement | aggregation (O-RU) |
| Object Class | |
| Switching | Packet Switched |
| Technology | |
| Generation | 5GS |
| Purpose | Network Operator's Energy Saving Community |

WG5—NES Performance counters Example.

A.14.2 Performance Counter Table

| | |
|---|---|
| Measurement Name | OR.ORU.POWER |
| Description | The epe-stats include the performance measurement |
| | for energy, power and environmental parameters. |
| | This counter would be useful to quantify the energy |
| | saving achieved |
| Collection Method | CC (Cumulative Counter) |
| Condition | TRx control/ASM |
| Measurement Result | Power |
| Measurement Type | OR.ORU.POWER |
| Measurement | aggregation (O-RU) |
| Object Class | |
| Switching | Packet Switched |
| Technology | |
| Generation | 5GS |
| Purpose | Network Operator's Energy Saving Community |

WG5—NES Performance counters Example.

A.14.2 Performance Counter Table

| | |
|---|---|
| Measurement Name | OR.ORU.Current |
| Description | The epe-stats include the performance measurement |
| | for energy, power and environmental parameters. |
| | This counter would be useful to quantify the energy |
| | saving achieved |
| Collection Method | CC (Cumulative Counter) |
| Condition | TRx control/ASM |
| Measurement Result | CURRENT |
| Measurement Type | OR.ORU.POWER |
| | aggregation (O-RU) |
| Measurement | |
| Object Class | |
| Switching | Packet Switched |
| Technology | |
| Generation | 5GS |
| Purpose | Network Operator's Energy Saving Community |

What is claimed is:

1. An apparatus configured to:
transmit an energy saving capability request to a distributed unit (DU);
receive, from the DU, an energy saving capability of a radio unit (RU) associated with the DU, wherein the energy saving capability comprises at least one of: a plurality of sleep modes of an Advanced Sleep Mode (ASM) and a plurality of array modes of an antenna mask (TRX) control that can be performed by the RU, and wherein the energy saving capability further comprises a capability range associated with the at least one of: the plurality of sleep modes and the plurality of array modes;
select a value within the capability range; and
transmit the selected value to the DU.

2. The apparatus according to claim 1, wherein:
each value within the capability range is associated with at least one of: a sleep mode of the plurality of sleep modes and an array mode of the plurality of array modes; and
the selected value within the capability range is associated with at least one of: a sleep mode of the plurality of sleep modes and an array mode of the plurality of array modes to be executed by the DU.

3. The apparatus according to claim 2, wherein the at least one of: the sleep mode of the plurality of sleep modes and the array mode of the plurality of array modes associated with the selected value is executed by the DU via a Section Type 4 (ST4) C-Plane message.

4. The apparatus according to claim 1, wherein the capability range comprises a range of values from a first value representing a maximum user experience and a minimum energy saving performance of the RU to a second value representing a minimum user experience and a maximum energy saving performance of the RU.

5. The apparatus according to claim 1, wherein each of the plurality of sleep modes is associated with a component of the RU and a sleep duration, and wherein the sleep duration comprises a duration when the associated component of the RU is disabled.

6. The apparatus according to claim 1, wherein each of the plurality of array modes is associated with an antenna element of the RU to disable.

7. The apparatus according to claim 1, wherein the apparatus is configured to select the value within the capability range using an Artificial Intelligence (AI)/Machine Learning (ML) model.

8. A method comprising:
transmitting an energy saving capability request to a distributed unit (DU);
receiving, from the DU, an energy saving capability of a radio unit (RU) associated with the DU, wherein the energy saving capability comprises at least one of: a plurality of sleep modes of an Advanced Sleep Mode (ASM) and a plurality of array modes of an antenna mask (TRX) control that can be performed by the RU, and wherein the energy saving capability further comprises a capability range associated with the at least one of: the plurality of sleep modes and the plurality of array modes;
selecting a value within the capability range; and
transmitting the selected value to the DU.

9. The method according to claim 8, wherein:
each value within the capability range is associated with at least one of: a sleep mode of the plurality of sleep modes and an array mode of the plurality of array modes; and
the selected value within the capability range is associated with at least one of: a sleep mode of the plurality of sleep modes and an array mode of the plurality of array modes to be executed by the DU.

10. The method according to claim 9, wherein the at least one of: the sleep mode of the plurality of sleep modes and the array mode of the plurality of array modes associated with the selected value is executed by the DU via a Section Type 4 (ST4) C-Plane message.

11. The method according to claim 8, wherein the capability range comprises a range of values from a first value representing a maximum user experience and a minimum energy saving performance of the RU to a second value representing a minimum user experience and a maximum energy saving performance of the RU.

12. The method according to claim 8, wherein each of the plurality of sleep modes is associated with a component of the RU and a sleep duration, and wherein the sleep duration comprises a duration when the associated component of the RU is disabled.

13. The method according to claim 8, wherein each of the plurality of array modes is associated with an antenna element of the RU to disable.

14. The method according to claim 8, wherein the value within the capability range is selected using an Artificial Intelligence (AI)/Machine Learning (ML) model.

15. A non-transitory computer-readable recording medium having recorded thereon instructions executable by an apparatus to cause the apparatus to perform a method comprising:
transmitting an energy saving capability request to a distributed unit (DU);
receiving, from the DU, an energy saving capability of a radio unit (RU) associated with the DU, wherein the energy saving capability comprises at least one of: a plurality of sleep modes of an Advanced Sleep Mode (ASM) and a plurality of array modes of an antenna mask (TRX) control that can be performed by the RU, and wherein the energy saving capability further comprises a capability range associated with the at least one of: the plurality of sleep modes and the plurality of array modes;
selecting a value within the capability range; and
transmitting the selected value to the DU.

16. The non-transitory computer-readable recording medium according to claim 15, wherein:
each value within the capability range is associated with at least one of: a sleep mode of the plurality of sleep modes and an array mode of the plurality of array modes; and
the selected value within the capability range is associated with at least one of: a sleep mode of the plurality of sleep modes and an array mode of the plurality of array modes to be executed by the DU.

17. The non-transitory computer-readable recording medium according to claim 15, wherein the at least one of: the sleep mode of the plurality of sleep modes and the array mode of the plurality of array modes associated with the selected value is executed by the DU via a Section Type 4 (ST4) C-Plane message.

18. The non-transitory computer-readable recording medium according to claim 15, wherein the capability range comprises a range of values from a first value representing a maximum user experience and a minimum energy saving performance of the RU to a second value representing a minimum user experience and a maximum energy saving performance of the RU.

19. The non-transitory computer-readable recording medium according to claim 15, wherein each of the plurality of sleep modes is associated with a component of the RU and a sleep duration, and wherein the sleep duration comprises a duration when the associated component of the RU is disabled.

20. The non-transitory computer-readable recording medium according to claim 15, wherein each of the plurality of array modes is associated with an antenna element of the RU to disable.
